(19) United States
(12) Patent Application Publication
(10) Pub. No.: US 2009/0284518 A1
(43) Pub. Date: Nov. 19, 2009

(54) Liquid crystal display device, liquid crystal display method, and television receiver

(76) Inventor: Daiichi Sawabe, Mie (JP)

Correspondence Address: HARNESS, DICKEY & PIERCE, P.L.C., P.O. BOX 8910, RESTON, VA, 20195, US

(21) Appl. No.: 12/308,078

(22) PCT Filed: Apr. 26, 2007
(86) PCT No.: PCT/JP2007/059021

§ 371 Date: Dec. 5, 2008

(30) Foreign Application Priority Data
Aug. 2, 2006 (JP) 2006-211368

(51) Int. Cl. G09G 3/36; G06F 3/038

(52) U.S. Cl. 345/213; 345/89

(57) ABSTRACT

A liquid crystal display device according to one embodiment of the present invention includes a display controller for outputting an image to each panel independently so that the images displayed on a first panel and a second panel are stacked with each other to form one image corresponding to an image source. The display controller includes a luminance ratio adjusting section which adjusts the gray scales of the image outputted, to each liquid crystal panel so that a display response period becomes shorter than a standard predetermined display response period in combining the gray scales, when one combined gray scale is obtained by combining the gray scales of the image outputted to each panel. This allows enhancement in contrast and moving image performance so as to realize a liquid crystal display device having high quality in displaying not only still images but also moving images.

### TECHNICAL FIELD

The present invention relates to a liquid crystal display device, a liquid crystal display method, and a television receiver, each of which improves contrast and moving image display performance.

### BACKGROUND ART

There are various techniques for improving contrast of a liquid crystal display device. The following Patent Documents 1 through 7 disclose such techniques.

Patent Document 1 discloses a technique for improving a contrast ratio by optimizing content and a surface area ratio of a yellow pigment in pigment components of a color filter. The technique successfully resolves a problem that a contrast ratio of a liquid crystal display is reduced by use of pigment molecules, which scatter and depolarize polarized light in the color filter. According to Patent Document 1, the technique improves the contrast ratio of a liquid crystal display device from 280 to 420.

Patent Document 2 discloses a technique for improving a contrast ratio by increasing transmittance and a degree of polarization of a polarizer. According to Patent Document 2, the technique improves the contrast ratio of a liquid crystal display device from 200 to 250.

Patent Documents 3 and 4 disclose a technique for improving contrast in a guest-host mode which makes use of light absorbability of a dichroic dye. For example, Patent Document 3 discloses a method of improving contrast with an arrangement in which a quarter-wavelength plate is provided between two layers of guest-host liquid crystal cells.

Here, Patent Document 3 discloses omission of polarizers. Further, Patent Document 4 discloses a technique of mixing a dichroic dye with liquid crystal which is employed in a dispersive liquid crystal mode. According to Patent Document 4, the contrast ratio is 101.

The techniques disclosed in Patent Documents 3 and 4, however, show relatively low contrast compared with other methods. In order to further improve the contrast, the techniques require: an improvement in light absorbability of the dichroic dye; an increase in a content of the dye; or an increase in thickness of a guest-host liquid crystal cell(s). All of these, however, will lead to new problems, such as technical problems, poor reliability, and poor response properties.

Patent Documents 5 and 6 disclose a method of improving contrast by an optical compensation technique with which a liquid crystal display panel and another liquid crystal panel for optical compensation are provided between a pair of polarizers.

In Patent Document 5, a retardation contrast ratio of a display cell, and a liquid crystal cell for optical compensation is improved from 14 to 35 in an STN mode.

In Patent document 6, a liquid crystal cell for optical compensation is provided to compensate for wavelength dependence that a liquid crystal cell of, for example, a TN mode exhibits during a black display. According to Patent Document 6, the contrast ratio is improved from 8 to 100.

Although the techniques disclosed in the aforementioned Patent Documents realize 1.2 times to 10 times or even greater increases in contrast ratio, an absolute value of contrast ratio is only about 35 to 420.

Further, as another contrast enhancing technique, for example, Patent Document 7 discloses a complex liquid crystal display device in which two liquid crystal panels are overlapped with each other, and their polarizers are positioned to form crossed Nicols. Patent Document 7 further describes that, while a single panel shows a contrast ratio of 100, two panels overlapped with each other can enhance the contrast ratio by three to four digit values.

### [Patent Document 1]

Japanese Unexamined Patent Publication No. 2001-188120 (Tokukai 2001-188120 (published on Jul. 10, 2001))
[Patent document 2]
Japanese Unexamined Patent Publication No. 2002-90536 (Tokukai 2002-90536 (published on Mar. 27, 2002))
[Patent document 3]
Japanese Unexamined Patent Publication No. 25629/1988 (Tokukaisho 63-25629 (published on Feb. 3, 1988))
[Patent document 4]
Japanese Unexamined Patent Publication No. 2194/1993 (Tokukaihei 5-2194 (published on Jan. 8, 1993))
[Patent document 5]
Japanese Unexamined Patent Publication No. 49021/1989 (Tokukaihei 1-49021 (published on Feb. 23, 1989))
[Patent document 6]
Japanese Unexamined Patent Publication No. 23/1990 (Tokukaihei 2-23 (published on Jan. 5, 1990))
[Patent document 7]
Japanese Unexamined Patent Publication No. 88197/1993 (Tokukaihei 5-88197 (published on Apr. 9, 1993))

### DISCLOSURE OF INVENTION

When a liquid crystal display device is used in displaying moving images of a TV broadcast or a movie, it is necessary to take into consideration not only contrast but also a feeling of afterimages as moving image performance. The feeling of afterimages is caused by a slow response speed of liquid crystal.

Although Patent Document 7 describes a technique for enhancing contrast, it does not focus on attaining both contrast enhancement and moving image performance enhancement.

The present invention is made in view of the problem. An object of the present invention is to provide a liquid crystal display device that has high display quality in displaying not only still images but also moving images by improving both contrast and moving image performance.

In order to attain the object, a liquid crystal display device according to the present invention, in which a plurality of liquid crystal panels is optically stacked with each other, and each of the liquid crystal panels outputs an image based on an image source, including: display control means for outputting images to each of the liquid crystal panels respectively and independently so that the images displayed on the liquid crystal panels are stacked with each other to form one image corresponding to the image source, the display control means including: gray scale adjusting means for adjusting gray scales of the image outputted to each of the liquid crystal panels so that a display response period in combining the gray scales becomes shorter than a standard predetermined display response period, when one combined gray scale is obtained by combining the gray scales of the image outputted to each of the liquid crystal panels.

In order to attain the object, a liquid crystal display method in which a plurality of liquid crystal panels is optically stacked with each other, and each of the liquid crystal panels outputs an image based on an image source in order to display the image, including the steps of: outputting images to each of the liquid crystal panels respectively and independently so that the images displayed on the liquid crystal panels are stacked with each other to form one image corresponding to the image source; and adjusting the gray scales of the image outputted to each of the liquid crystal panels so that the display response period in combining the gray scales becomes shorter than the standard predetermined display response period, when one combined gray scale is obtained by combining the gray scales of the image outputted to each of the liquid crystal panels.

Generally, a response period of crystal liquid differs depending on a gray scale. A graph of FIG. 20 shows a relationship between the response period and the gray scale, for example.

Therefore, the display response period of the liquid crystal display device can become shorter than the standard display response period, with the arrangement described above, in which a liquid crystal display device includes gray scale adjusting means which adjusts gray scales of the image outputted to each of the liquid crystal panels so that a display response period in combining the gray scales becomes shorter than a standard predetermined display response period, when one combined gray scale is obtained by combining the gray scales of the image outputted to each of the liquid crystal panel.

This allows the liquid crystal display device to have the display response period shorter than the standard display response period all the time. Thereby, it becomes possible to reduce an afterimage phenomenon in displaying moving images, which afterimage phenomenon is caused by a long display response period. As a result, the moving image performance can be enhanced.

Further, compared with a single liquid crystal panel, contrast can be more enhanced because a plurality of the liquid crystal panels is optically stacked with each other, and each of the liquid crystal panels displays images based on the image source.

For the reasons set forth above, the liquid crystal display device having the arrangement can display moving images having high display quality with high moving image performance and high contrast.

Generally, with a liquid crystal display device, a display response period can be found from a luminance ratio obtained from a relationship between a gray scale of an inputted image source and a maximum gray scale on a liquid crystal panel. For example, with a liquid crystal display device with two assembled liquid crystal panels, a display response period considerably differs depending on a combination of luminance ratios of first and second liquid crystal panels.

For this reason, the gray scale adjusting means may include: gray scale-luminance ratio converting means for converting gray scales of the inputted image source into luminance ratios found from relationships between the gray scales and a maximum gray scale; selecting means for selecting a combination of the luminance ratios for a shortest display response period from among combinations of the luminance ratios with which the display response period in combining the gray scales becomes shorter than the standard predetermined display response period, when one combined gray scale is obtained by combining the gray scales of the image outputted to each of the liquid crystal panels in accordance with the luminance ratios converted by the gray scale-luminance ratio converting means; and luminance ratio-gray scale converting means for converting, into gray scales, each of the luminance ratios in the combination selected by the selecting means for the shortest display response period.

With the arrangement, the gray scales of the inputted image source are converted into the luminance ratios obtained from the relationships between the gray scales and the maximum gray scale, and then, the combination of the luminance ratios for the shortest display response period is selected from the luminance ratios thus obtained, after that, the selected luminance ratios are again converted into gray scales. Therefore, by having a setting to avoid a combination for a longer luminance ratio than the standard predetermined display response period, it is possible to reduce a slow response in specific halftone.

Further, the liquid crystal display device according to the present invention may include: luminance ratio combination storing means for storing the combinations of the luminance ratios with which the display response period in combining the gray scales becomes shorter than the standard predetermined display response period, wherein: according to the luminance ratios converted by the gray scale-luminance ratio converting means, the selecting means selects the combination of the luminance ratios for the shortest display response period from the combinations of the luminance ratios stored in the luminance ratio combination storing means.

With the arrangement, the selecting means selects an appropriate combination of the luminance ratios from among the combinations stored in advance in the luminance ratio combination storing means, so that a period for selecting the appropriate luminance ratio can be considerably reduced.

The selecting means may include judging means which provides the standard predetermined display response period as a display period of one frame, and judges the combination of the luminance ratios shorter than the display period of one frame, as the combination of the luminance ratios for the shortest display response period.

With the arrangement, the combination of the luminance ratios is selected by the selecting means based on the display period of one frame. That is, an appropriate display response period for liquid crystal display is set to the liquid crystal display. This makes it possible to further reduce the afterimage phenomenon in displaying moving images.

Further, when the judging means judges that there is a plurality of combinations of the luminance ratios for the shorter display response period than the display period of one frame, the selecting means selects one having a smallest difference in display response period between the liquid crystal panels, as the combination of the luminance ratios for the shortest display response period

With the arrangement, an appropriate display response period for liquid crystal display is set to the liquid crystal display, because when the judging means judges there is a plurality of combinations of the luminance ratios for the shorter display response period than the display period of one frame, the selecting means selects one having the smallest difference in display response periods of each of the liquid crystal panels, as the combination of the luminance ratios for the shortest display response period. This makes it possible to furthermore reduce the afterimage phenomenon in displaying moving images.

When according to gray scales of a prior frame on each of the liquid crystal panels, one combined gray scale is obtained by combining the gray scales of the image outputted to each of the liquid crystal panels, the gray scale adjusting means adjusts the gray scales of the image respectively outputted to each of the liquid crystal panels so that the display response period in combining the gray scales becomes shorter than the standard predetermined display response period.

With the arrangement, it is possible to merely set gray scales of a present frame with respect to those of a prior frame, and conversion from the gray scales to the luminance ratios, and from the luminance ratios to the gray scales is unnecessary. This allows the display response period to be always short, so as to improve moving image display properties.

A television receiver according to the present invention includes a tuner section for receiving a television broadcast; and a display device for displaying the television broadcast received at the tuner section, wherein: the display device is the compound display device described above.

With the arrangement, it is possible to provide a television receiver having high quality in displaying moving images.

### BRIEF DESCRIPTION OF DRAWINGS

FIG. 1 is a schematic cross-sectional view of a liquid crystal display device, illustrating an embodiment of the present invention.

FIG. 2 illustrates a positional relationship between polarizers and panels in the liquid crystal display device of FIG. 1.

FIG. 3 is a plan view illustrating the vicinity of a pixel electrode in the liquid crystal display device of FIG. 1.

FIG. 4 is a block diagram schematically illustrating a drive system for driving the liquid crystal display device of FIG. 1.

FIG. 5 illustrates connections between drivers and panel drive circuits of the liquid crystal display device of FIG. 1.

FIG. 6 is a block diagram schematically illustrating a backlight provided in the liquid crystal display device of FIG. 1.

FIG. 7 is a block diagram of a display controller which is a drive circuit for driving the liquid crystal display device of FIG. 1.

FIG. 8 is a cross-sectional view schematically illustrating a liquid crystal display device with a single liquid crystal panel.

FIG. 9 illustrates a positional relationship between polarizers and a panel in the liquid crystal display device of FIG. 8.

FIG. 10(a) illustrates a contrast enhancement mechanism.

FIG. 10(b) illustrates a contrast enhancement mechanism.

FIG. 10(c) illustrates a contrast enhancement mechanism.

FIG. 11(a) is a graph which compares a structure I of FIG. 10(a) and a structure II of FIG. 10(b) in relationship between a transmission spectrum wavelength and cross transmittance when the polarizers are viewed in a frontal direction.

FIG. 11(b) is a graph which compares the structure I and the structure II in relationship between a transmission spectrum wavelength and a parallel transmittance when the polarizers are viewed in a frontal direction.

FIG. 11(c) is a graph which compares the structure I and the structure II in relationship between a transmission spectrum wavelength and cross transmittance when the polarizers are viewed in an oblique direction (azimuth: 45°, −polar angle: 60°).

FIG. 11(d) is a graph which compares the structure I and the structure II in relationship between a transmission spectrum wavelength and a parallel transmittance when the polarizers are viewed in an oblique direction (azimuth: 45°, −polar angle: 60°).

FIG. 12(a) is a graph which shows a relationship between a polar angle and transmittance in a white display.

FIG. 12(b) is a graph which shows a relationship between a polar angle and transmittance in a black display.

FIG. 12(c) is a graph which shows a relationship between a polar angle and contrast.

FIG. 13(a) is a perspective view illustrating a state where the polarizers are positioned to form crossed Nicols.

FIG. 13(b) is a graph which shows a relationship between a Nicol angle Φ and cross transmittance.

FIG. 14(a) is a graph which shows a relationship between a thickness of the polarizers that are positioned to form a pair of crossed Nicols, and transmittance (cross transmittance) in the black display.

FIG. 14(b) is a graph which shows a relationship between a thickness of the polarizers that are positioned to form a pair of crossed Nicols, and transmittance (cross transmittance) in the white display.

FIG. 14(c) is a graph which shows a relationship between a thickness of the polarizers that are positioned to form a pair of crossed Nicols, and contrast.

FIG. 15(a) shows crossed-Nicols view angle properties of the structure I in which two polarizers form a pair of crossed Nicols.

FIG. 15(b) shows crossed-Nicols view angle properties of the structure II in which three polarizers form two pairs of crossed Nicols.

FIG. 16(a) shows contrast view angle properties of the structure I in which two polarizers form a pair of crossed-Nicols.

FIG. 16(b) shows contrast view angle properties of the structure II in which three polarizers form two pairs of crossed Nicols.

FIG. 17 is a block diagram of a main arrangement of the display controller of FIG. 7, illustrating an embodiment of the present invention.

FIG. 18 is a table showing display response periods needed for each initial luminance ratio to change to an end luminance ratio in the liquid crystal display device illustrated in FIG. 1.

FIG. 19 is a graph of FIG. 18, showing display response periods needed for an initial luminance ratio of 0 to change to an end luminance ratio.

FIG. 20 is a table showing a relationship between gray scales and response speeds on a prior frame and a current frame.

FIG. 21 is a graph of FIG. 20, showing a relationship between gray scales and response speeds, in a case where the gray scale of the prior frame is 0.

FIG. 22 is a table showing combinations of the gray scales of the present frame against those of the prior frame, in a case where two liquid crystal panels that have the properties showed in the graph of FIG. 21 are assembled with each other.

FIG. 23 is a table of a modified example of an embodiment of the present invention, showing display response periods needed for initial luminance ratios to become end luminance ratios in the aforementioned liquid crystal display device.

FIG. 24 is a block diagram schematically illustrating a television receiver including the liquid crystal display device of the present invention.

FIG. 25 is a block diagram illustrating a relationship between a tuner section and the liquid crystal display device in the television receiver of FIG. 24.

FIG. 26 is an exploded perspective view of the television receiver of FIG. 24.

### BEST MODE FOR CARRYING OUT THE INVENTION

One embodiment of the present invention is described below.

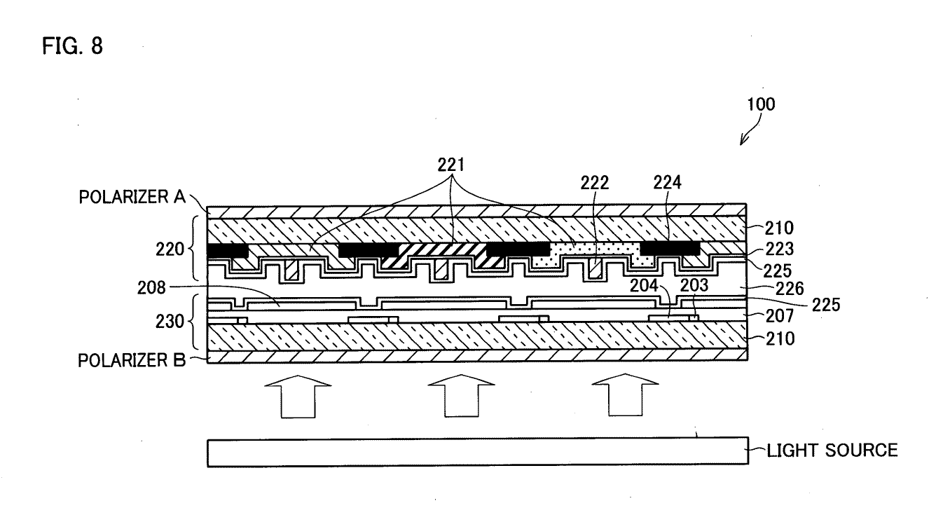

A general liquid crystal display device is arranged such that polarizers A and B are stacked with a liquid crystal panel to which a color filter and a drive substrate are provided, as illustrated in FIG. 8. The following description deals with an MVA (Multidomain Vertical Alignment) liquid crystal display device.

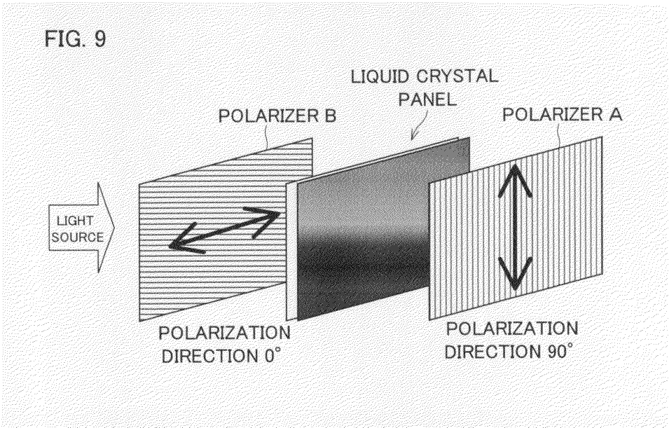

The polarizers A and B are positioned so that their polarization axes are orthogonal to each other, as illustrated in FIG. 9. Alignment of the liquid crystal is set to tilt at an azimuth of 45° with respect to the polarization axes of the polarizers A and B when a threshold voltage is applied to pixel electrodes 8 (see FIG. 8). With the arrangement, the axis of incident light, which has come through and polarized by the polarizer A, is rotated when going through a liquid crystal layer of the liquid crystal panel. The light thus comes out of the polarizer B. When a voltage equal to or less than the threshold voltage is applied to the pixel electrodes, the liquid crystal aligns vertical to the substrate. The polarization angle of the polarized incident light is not changed, so as to produce a black display. In an MVA mode, a direction in which the liquid crystal tilts when applied with a voltage is divided into four directions (multidomain) to realize a large view angle.

A double-polarizer structure, however, has a limit in contrast enhancement. The inventors of the present invention have found that use of three polarizers, each of which is positioned to form crossed Nicols, in combination with two liquid crystal display panels improves shutter performance in both front and oblique directions.

The following deals with a contrast enhancement mechanism.

Specifically, the inventors of the present invention have made the following findings.

(1) Front Direction

Depolarization (scattering of CF and the like) in the panel causes leakage of light in a direction of a transmission axis of crossed Nicols. In a triple-polarizer structure described above, a third polarizer is positioned such that its absorption axis accords with the leakage of light in a direction of a transmission axis of a second polarizer. The leakage is thus eliminated.

(2) Oblique Direction

An amount of light leakage is less likely to change with an increase in Nicol angle φ of polarizers, that is, black is less likely to lose its depth in oblique directions with an increase in Nicol angle φ.

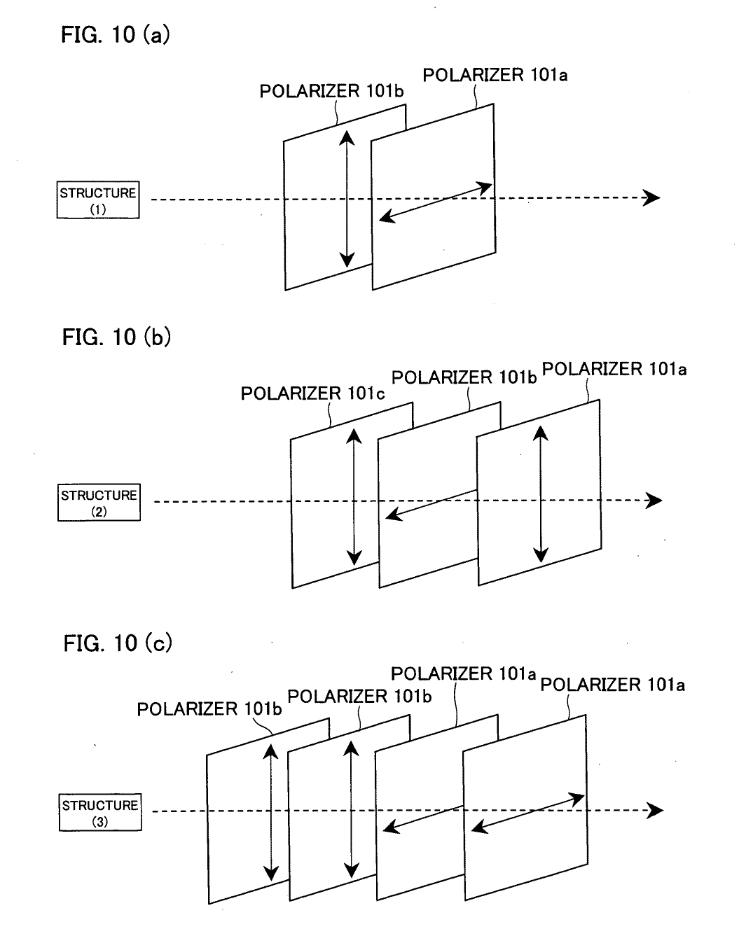

From the findings above, the inventors of the present invention found that the triple-polarizer structure can considerably enhance contrast in a liquid crystal display device. The following deals with the contrast improvement mechanism with reference to FIGS. 10(a) through 10(c), 11(a) through 11(d), 12(a) through 12(c), 13(a), 13(b), 14(a) through 14(c), 15(a), 15(b), 16(a), 16(b), and Table 1. Here, the double-polarizer structure is referred to as structure I, and the triple-polarizer structure is referred to as structure II. Contrast enhancement in oblique directions is essentially based on a polarizer structure. Therefore, a modeling here is explained with no liquid crystal panels but only polarizers.

FIG. 10(a) illustrates an example of the structure I in which two polarizers 101a and 101b are positioned to form crossed Nicols. FIG. 10(a) assumes a case where a single liquid crystal display panel is provided in the structure I. FIG. 10(b) illustrates an example of the structure II in which three polarizers 101a, 101b, and 101c are positioned to form crossed Nicols with each other. That is, FIG. 10(b) assumes a case where two liquid crystal display panels are provided in the structure II, and therefore two pairs of the polarizers are positioned to form crossed Nicols. FIG. 10(c) illustrates an example of a structure in which the polarizers 101a and 101b, which face each other, are positioned to form crossed Nicols, and each of these is attached with an additional polarizer from outside. The additional polarizers have the same polarization direction as the polarizers 101a and 101b respectively. The structure illustrated in FIG. 10(c) includes four polarizers, but only a pair of the polarizers is positioned to form crossed Nicols and hold one liquid crystal display panel therebetween.

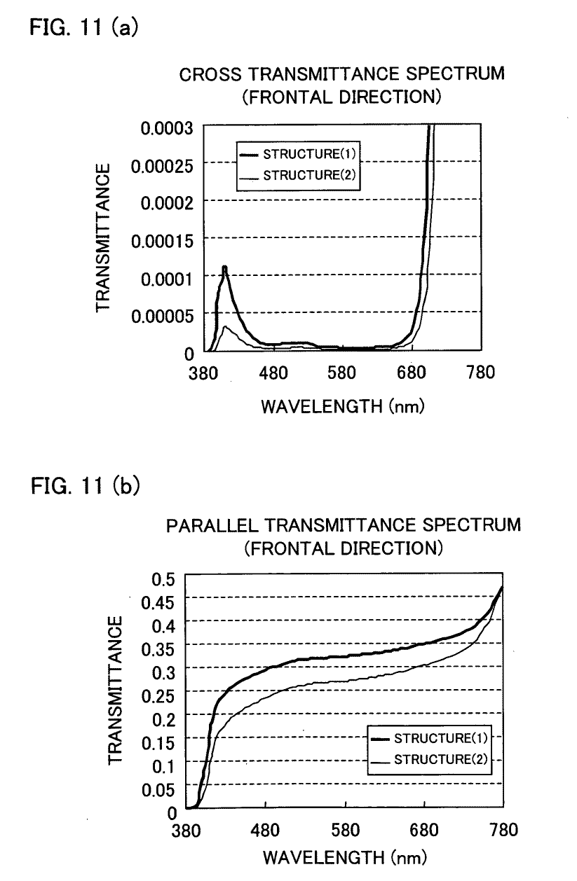

Transmittance at which a liquid crystal display panel displays black is modeled as cross transmittance, that is, transmittance of polarizers that are positioned to form crossed Nicols without a liquid crystal display panel therebetween. Herein, the resultant transmittance model is referred to as a black display. Meanwhile, transmittance at which a liquid crystal display panel displays white is modeled as parallel transmittance, that is, transmittance of the polarizers that are positioned to form parallel Nicols without a liquid crystal display panel therebetween. The resultant transmittance model is referred to as a white display, herein. FIGS. 11(a) through 11(d) are graphs showing examples of a relationship between a wavelength and transmittance of transmission spectrum when the polarizers are viewed in frontal and oblique directions. The modeled transmittances are ideal values of transmittances of the white and black displays in a case where the polarizers are positioned to form crossed Nicols, and hold a liquid crystal display panel between them.

FIG. 11(a) is a graph comparing the structures I and II in relationship between a wavelength and cross transmittance of the transmission spectrum when the polarizers are viewed in a frontal direction. The graph demonstrates that the structures I and II tend to be similar in transmittance properties when the black display is viewed in a frontal direction.

FIG. 11(b) is a graph comparing the structures I and II in relationship between the wavelength and parallel transmittance of the transmission spectrum when the polarizers are viewed in the frontal direction. The graph demonstrates that the structures I and II tend to be similar in transmittance properties when the white display is viewed in the frontal direction.

FIG. 11(c) is a graph comparing the structures I and II in relationship between the wavelength and cross transmittance of the transmission spectrum when the polarizers are viewed in an oblique direction (azimuth: 45°, −polar angle: 60°). The graph shows the transmittance properties when the black display is viewed in the oblique directions. The structure II has a transmittance of 0 in almost all wavelength bands, while the structure I has slight transmittance in almost all the wavelength bands. In other words, in the black display, the double-polarizer structure has leakage of light (that is, a reduction in depth of black) at an oblique view angle, while the leakage of light (a reduction in depth of black) is suppressed at the oblique view angle with the triple-polarizer structure.

FIG. 11(d) is a graph comparing the structures I and II in relationship between the wavelength and parallel transmittance of the transmission spectrum when the polarizers are viewed in an oblique direction (azimuth: 45°, −polar angle: 60°). The graph demonstrates that the structures I and II tend to be similar in transmittance properties when the white display is viewed in the oblique direction.

For the reasons set forth above, in the case of the white display, as shown in FIGS. 11(b) and 11(d), the transmittance properties are almost the same in both frontal and oblique directions regardless of the number of the polarizers, i.e. the number of pairs of crossed Nicols formed by the polarizers.

In the case of the black display, however, as shown in FIG. 11(c), the structure I having a pair of crossed Nicols has a reduction in depth of black at the oblique view angle, while the reduction in depth of black is suppressed with the structure II having two pairs of crossed Nicols.

For example, the following Table 1 shows a relationship between transmittances at frontal and oblique (azimuth: 45°, −polar angle: 60°) view angles when the transmittance spectrum wavelength is 550 nm.

TABLE 1
550 nm

| | Front | | | Oblique position (45° to 60°) | | |
|---|---|---|---|---|---|---|
| | Structure | | | Structure | | |
| | I | II | II/I | I | II | II/I |
| Parallel | 0.319 | 0.265 | 0832 | 0.274499 | 0.219084 | 0.798 |
| Cross | 0.000005 | 0.000002 | 0.4 | 0.01105 | 0.000398 | 0.0360 |
| Parallel/ | 63782 | 132645 | 2.1 | 24.8 | 550.5 | 22.2 |
| Cross | | | | | | |

In Table 1, “Parallel” stands for parallel transmittance, and shows the transmittance in the white display. “Cross” stands for cross transmittance, and shows the transmittance in the black display. Accordingly, “Parallel/Cross” shows contrast.

Table 1 demonstrates that the structure II has approximately twice a frontal contrast of the structure I, and approximately 22 times an oblique contrast of the structure I, that is, the oblique contrast considerably improves with the structure II.

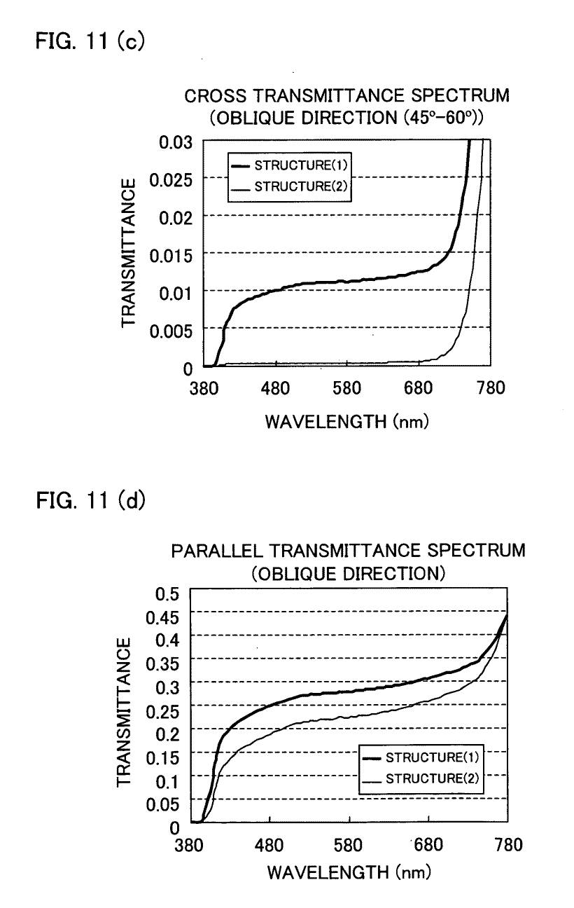

Next, the following description deals with view angle properties in the white and black displays with reference to FIGS. 12(a) through 12(c). In the description, an azimuth to the polarizer is set to 45°, and the transmission spectrum wavelength is set to 550 nm.

FIG. 12(a) is a graph showing a relationship between a polar angle and transmittance in the white display. The graph demonstrates that the structures I and II tend to be similar in view angle properties (parallel view angle properties), although the structure II is lower in transmittance than the structure I as a whole.

FIG. 12(b) is a graph showing a relationship between a polar angle and transmittance in the black display. The graph demonstrates that transmittance is suppressed at the oblique view angle (polar angle: around ±80°) with the structure II while the transmittance becomes higher at the oblique view angle with the structure I. In other words, the structure I has a significant reduction in depth of black at the oblique view angle compared with the structure II.

FIG. 12(c) is a graph showing a relationship between a polar angle and contrast. The graph demonstrates that contrast is successfully enhanced with the structure II compared with the structure I. In FIG. 12(c), a line of the structure II becomes flat around a polar angle of 0°. This is because the transmittance around the polar angle of 0° in the black display becomes too small, so that it loses a significant digit. As a result, it cannot be calculated. In actual fact, the line would make a smooth curve.

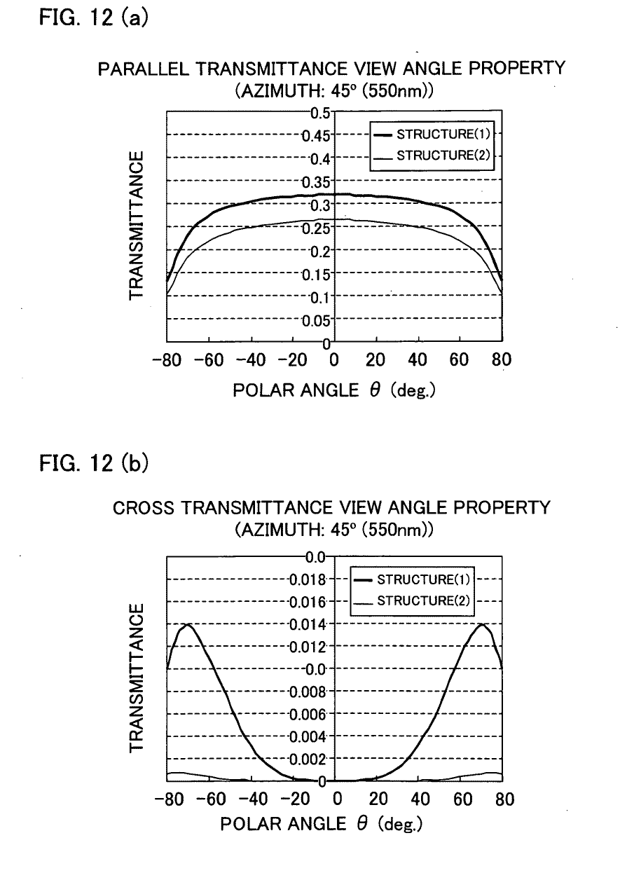

Next, the following description explains the phenomenon that the amount of light leakage is less likely to change with an increase in Nicol angle φ of the polarizers, that is, the depth of black tends not to decrease with an increase in Nicol angle φ at oblique view angles. The description is made with reference to FIGS. 13(a) and 13(b). The Nicol angle φ of the polarizers is an angle in a state where polarization axes of the polarizers facing each other are in a twist relationship, as illustrated in FIG. 13(a). FIG. 13(a) is a perspective view of the polarizers positioned to form crossed Nicols, wherein the Nicol angle φ changes from an angle of 90° (which is the increase in Nicol angle).

FIG. 13(b) is a graph showing a relationship between a Nicol angle φ and cross transmittance. Calculations for the graph are carried out with use of ideal polarizers (parallel Nicol transmittance: 50%, cross Nicol transmittance: 0%). The graph demonstrates that the structure II has less changes in transmittance with respect to changes in Nicol angle φ than the structure I. In other words, the changes in Nicol angle φ have less influence on the triple-polarizer structure than on the double-polarizer structure.

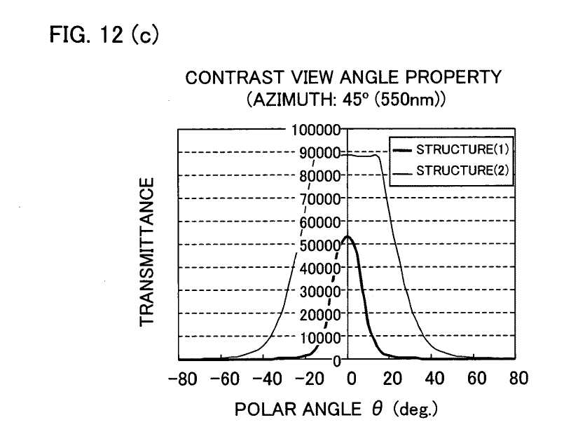

Next, the following description deals with thickness dependence of the polarizers with reference to FIGS. 14(a) through 14(c). Here, the thickness of the polarizers is adjusted in such a manner that, as illustrated in FIG. 10(c), to the polarizers positioned to form a pair of crossed Nicols, additional polarizers that have the same polarization axes as those of the aforementioned polarizers are respectively stacked one by one. In an example illustrated in FIG. 10(c), the polarizers 101a and 101b, which are positioned to form a pair of crossed Nicols, are stacked respectively with additional polarizers 101a and 101b, which have the polarization axes in the same directions as those of the above polarizers 101a and 101b respectively. In this case, the structure includes two other polarizers in addition to the two polarizers positioned to form a pair of crossed Nicols. This structure is referred to as “one crossed pair −2”. Likewise, with each addition of two polarizers, the number in the wording “one crossed pair −2” increases. For example, it increases to “one crossed pair −3” when two more polarizers are added. FIGS. 14(a) through 14(c) are graphs resulted from values, each of which are measured at an azimuth of 45° and a polar angle of 60°.

FIG. 14(a) is a graph showing a relationship between a thickness and transmittance (cross transmittance) of the polarizers positioned to form a pair of crossed Nicols in the black display. The graph also shows transmittance of the polarizers positioned to form two pairs of crossed Nicols, for comparison.

FIG. 14(b) is a graph showing a relationship between a thickness and transmittance (parallel transmittance) of the polarizers positioned to form a pair of crossed Nicols in the white display. The graph also shows transmittance of the polarizers positioned to form two pairs of crossed Nicols, for comparison.

Stacking polarizers can reduce the transmittance in the black display, as showed by the graph of FIG. 14(a). However, this also reduces the transmittance in the white display, as showed by the graph of FIG. 14(b). That is, the transmittance in the white display will be decreased, if the polarizers are simply stacked with each other in order to suppress the reduction in depth of black in the black display.

FIG. 14(c) is a graph showing a relationship between the thickness and contrast of the polarizers positioned to form a pair of crossed Nicols. The graph also shows the contrast of the polarizers positioned to form two pairs of crossed Nicols, for comparison.

These graphs of FIGS. 14(a) through 14(c) demonstrate that with the polarizers positioned to form two pairs of crossed Nicols, it becomes possible to suppress the reduction in depth of black in the black display, and also prevent the reduction in transmittance in the white display. Further, the polarizers positioned to form two pairs of crossed Nicols are constituted by a total of three polarizers. This enables a liquid crystal display device to have significant improvement in contrast without an increase in thickness as a whole.

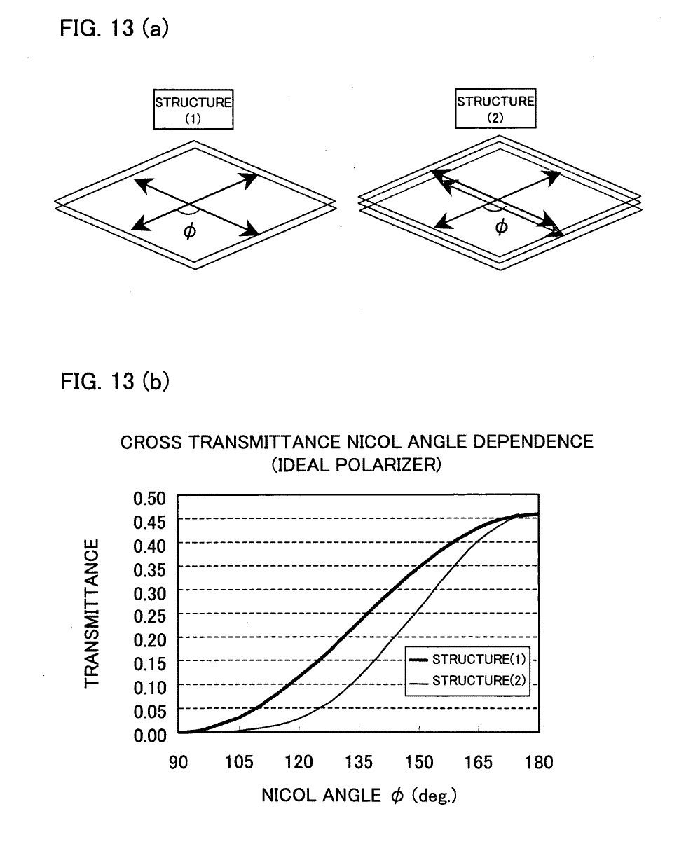

FIGS. 15(a) and 15(b) specifically show view angle properties of crossed Nicols transmittance. FIG. 15(a) shows crossed Nicols view angle properties of the structure I, that is, the double-polarizer structure having a pair of crossed Nicols. FIG. 15(b) shows the crossed Nicols view angle properties of the structure II, that is, the triple-polarizer structure having two pairs of crossed Nicols.

FIGS. 15(a) and 15(b) demonstrate that the reduction in depth of black (corresponding to an increase in transmittance in the black display) hardly occurs in the structure having two pairs of crossed Nicols (especially at angles of 45°, 135°, 225°, and 315°).

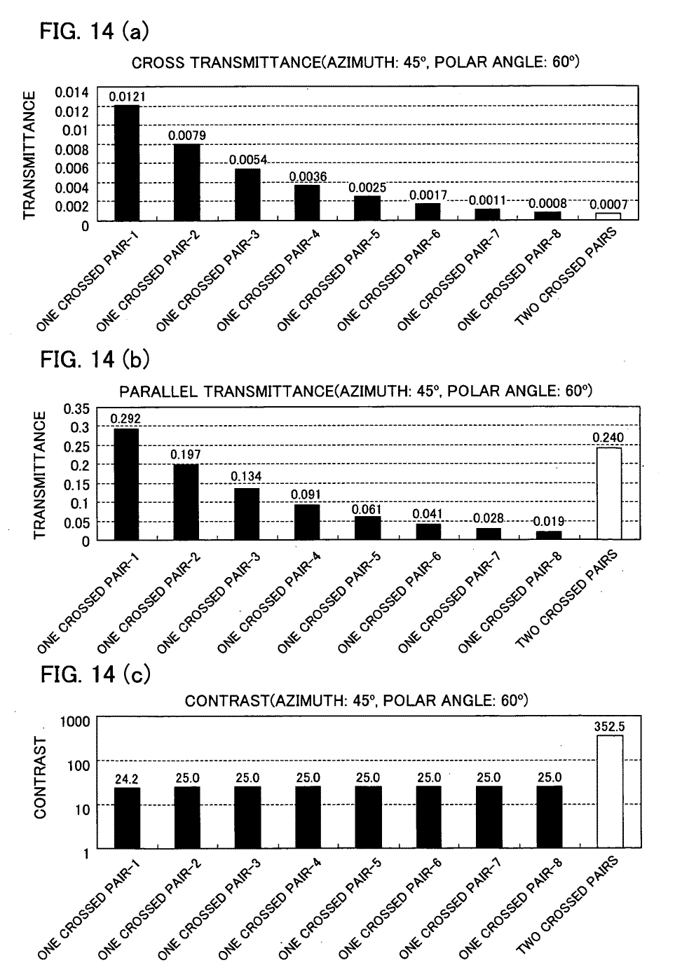

Further, FIGS. 16(a) and 16(b) specifically show contrast view angle properties (parallel/cross luminance). FIG. 16(a) shows contrast view angle properties of the structure I, that is, the double-polarizer structure having a pair of crossed Nicols. FIG. 16(b) shows contrast view angle properties of the structure II, that is, the triple-polarizer structure having two pairs of crossed Nicols.

FIGS. 16(a) and 16(b) demonstrate that the structure having two pairs of crossed Nicols has higher enhancement in contrast than the structure having a pair of crossed Nicols.

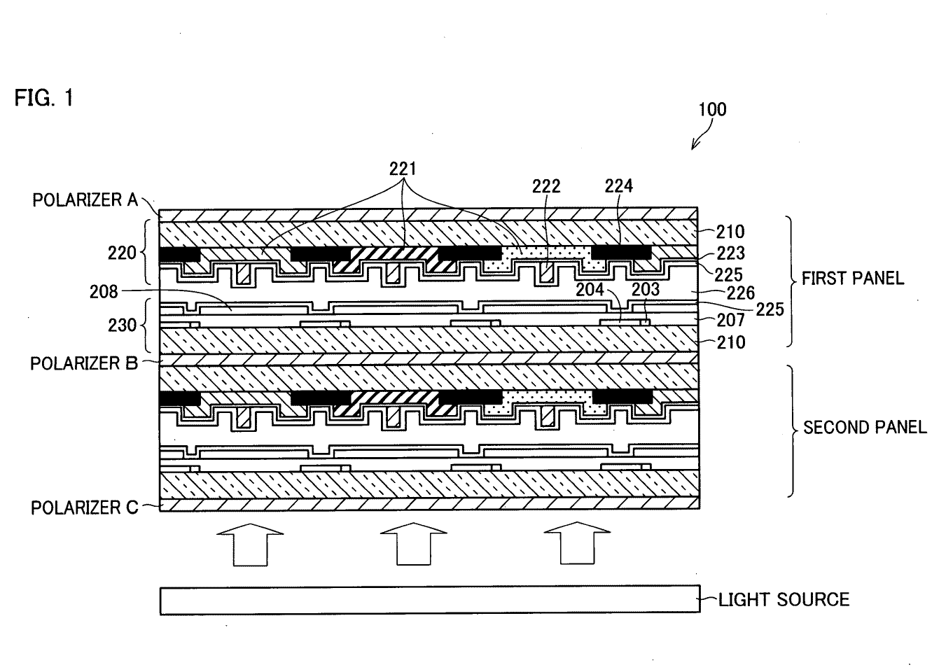

Here, the description deals with a liquid crystal display device which makes use of the contrast enhancement mechanism described above, with reference to FIGS. 1 through 7. The description deals with only the case of using two liquid crystal panels, for convenience.

FIG. 1 is a cross-sectional view schematically illustrating a liquid crystal display device 100 in accordance with the present embodiment of the present invention.

The liquid crystal display device 100 is arranged such that first and second panels, and polarizers A, B, and C are stacked with each other alternatively, as illustrated in FIG. 1.

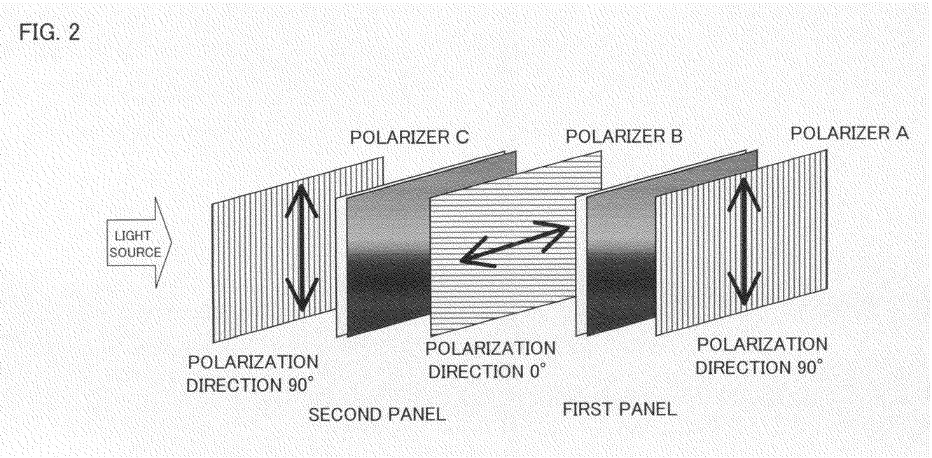

FIG. 2 illustrates a positioning of the polarizers and the liquid crystal panels in the liquid crystal display device 100 illustrated in FIG. 1. In FIG. 2, the polarizers A and B are arranged such that their polarization axes are orthogonal to each other. The polarizers B and C are also arranged the same. In other words, the polarizers A and B, and B and C are positioned to form crossed Nicols.

The first and second panels are formed respectively such that liquid crystal is sealed between a pair of transparent substrates (a color filter substrate 220 and an active matrix substrate 230). Each of the panels includes means for electrically changing alignment of liquid crystal so as to arbitrarily select one of the following three states: a state where polarized light, which has entered the polarizer A from a light source, is rotated at approximately 90°; another state where the polarized light is not rotated; and an intermediate state between the aforementioned states.

Each of the first and second panels includes a color filter, and has a function to display images with use of a plurality of pixels. Examples of a display mode having such a function include the TN (Twisted Nematic) mode, the VA (Vertical Alignment) mode, an IPS (In Plain Switching) mode, an FFS (Fringe Field Switching) mode, and any combinations of them. Among these modes, the VA mode is suitable because it exhibits high contrast without combining with any other modes. Note that the description here is made with the MVA (Multidomain Vertical Alignment) mode, however, the IPS mode and the FFS mode are also sufficiently effective because both of them operate in normally black mode. The liquid crystal is driven by an active matrix drive by use of TFTs (Thin Film Transistors). Details regarding a manufacturing method of MVA are disclosed in Japanese Unexamined Patent Publication No. 83523/2001 (Tokukaikhei 13-83523), for example.

The first and second panels of the liquid crystal display device 100 have the same arrangement in which a color filter substrate 220 and an active matrix substrate 230 are provided to face each other, and a specific distance between them is kept by use of plastic beads, or columnar resin objects formed on the color filter substrate 220, for example, as spacers (not illustrated). The liquid crystal is sealed between a pair of the substrates (the color filter substrate 220 and the active matrix substrate 230). To a surface of each substrate, which surface will be in contact with liquid crystal, a vertical alignment film 225 is formed. The liquid crystal is nematic liquid crystal with negative dielectric anisotropy.

The color filter 220 is formed such that a color filter 221, a black matrix 224, and other components are formed on a transparent substrate 210. The color filter 220 is also provided with alignment controlling projections 222 for controlling an alignment direction of the liquid crystal.

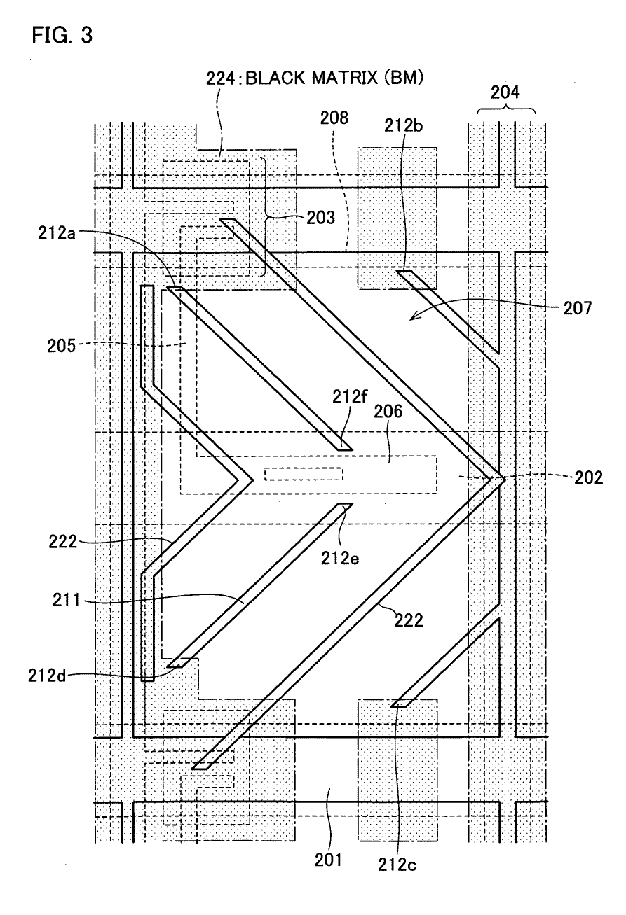

The active matrix substrate 230 is formed such that TFT elements 203, pixel electrodes 208, and other components are formed on the transparent substrate 210. The active matrix substrate 230 is also provided with alignment controlling slit patterns 211 for controlling the alignment direction of the liquid crystal. The alignment controlling projections 222, and the black matrix 224 for shutting unnecessary light which causes a reduction in display quality are patterns formed on the color filter substrate 220. The patterns are projected on the active matrix substrate 230 in FIG. 3. The liquid crystal molecules tilt in a direction vertical to the projections 222 and the slit patterns 211, when a voltage equal to or more than a threshold voltage is applied to the pixel electrode 208. In the present embodiment, the projections 222 and the slit patterns 211 are formed so that the liquid crystal aligns in a direction at an azimuth of 45° to the polarization axis of the polarizer.

As such, the first and second panels are arranged such that red (R), green (G), and blue (B) pixels of each color filter 221 have the same position when viewed in a direction vertical to the panels. Specifically, in the arrangement, the R pixel of the first panel corresponds to the R pixel of the second panel, the G pixel of the first panel corresponds to the G pixel of the second panel, and the B pixel of the first panel corresponds to the B pixel of the second panel, when viewed in the direction vertical to the panels.

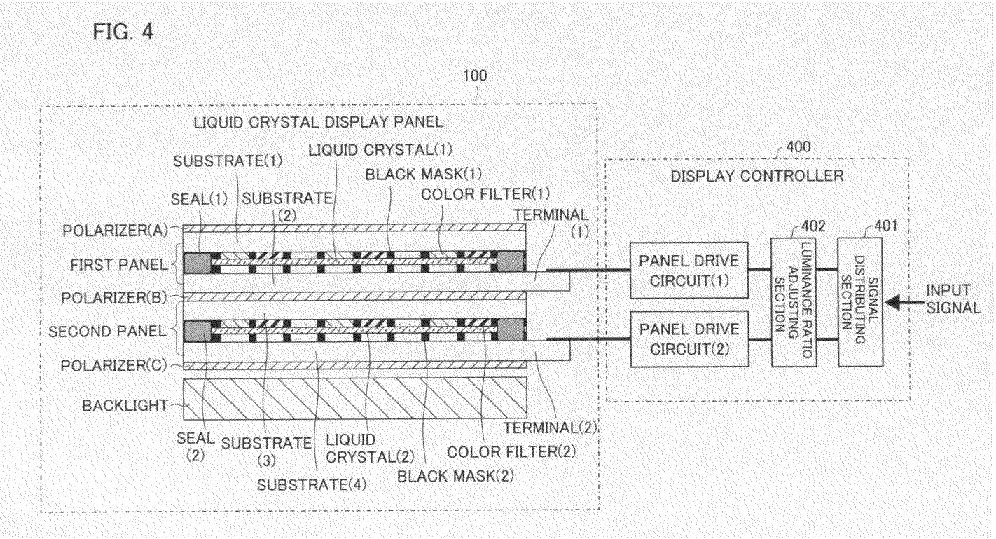

FIG. 4 schematically illustrates a drive system of the liquid crystal display device 100 with the arrangement described above.

The drive system includes a display controller 400 which is necessary to display images on the liquid crystal display device 100. With the arrangement, appropriate image data based on the input signal is outputted to the liquid crystal display device 100.

The display controller 400 includes first panel drive circuit (1) and second panel drive circuit (2) for respectively driving the first and second panels with predetermined signals. The display controller 400 further includes: a signal distributing section 401 for distributing image source signals to the first panel drive circuit (1) and the second panel drive circuit (2); and a luminance ratio adjusting section 402 for adjusting luminance ratios with respect to the image source signals distributed by the signal distributing section 401. The luminance ratio adjusting section 402 will be described later in detail.

Here, the input signals represent not only image signals from a TV receiver, a VTR, a DVD player and the like, but also signals produced by processing these signals.

Therefore, the display controller 400 is arranged to transfer such signals to each panel so that the liquid crystal display device 100 can display appropriate images.

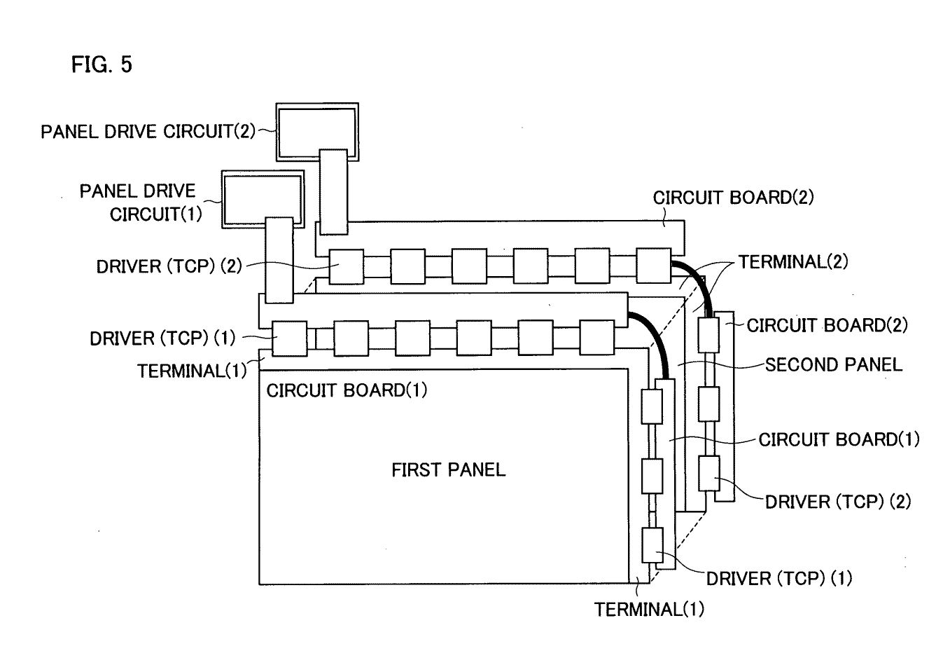

FIG. 5 illustrates connections between the first and second panels, and the panel drive circuits thereof respectively. The polarizers are omitted in FIG. 5.

The panel drive circuit (1) of the first panel is connected, via drivers (TCP) (1), to a terminal (1) provided on a circuit board (1) of the first panel. In other words, the drivers (TCP) (1) are connected to the first panel, and attached to the panel drive circuit (1) so that the first panel is connected to the circuit board (1).

An explanation regarding how to connect the second panel drive circuit (2) to the second panel is omitted, because it is carried out in the same manner as the panel drive circuit (1) is connected to the first panel.

Next, the following explains an operation of the liquid crystal display device 100 with the arrangement described above.

The pixels of the first panel are driven based on the display signals, and the pixels of the second panel, which pixels correspond to those of the first panel in the direction vertical to the panels, are driven based on the first panel. When a section (a construction 1) constituted by the polarizer A, the first panel, and the polarizer B transmits light, so does another section (a construction 2) constituted by the polarizer B, the second panel, and the polarizer C. When the construction 1 does not transmit light, nor does the construction 2.

The first and second panels may be inputted with either the same image signals, or signals that are associated but different.

The following explains a method of manufacturing the active matrix substrate 230 and the color filter substrate 220.

First, the method of manufacturing the active matrix substrate 230 will be explained.

First of all, as illustrated in FIG. 3, in order to form a scan signal lines (gate wires, gate lines, gate voltage lines, or gate bus lines) 201, and auxiliary capacitance lines 202, a metal film such as a Ti/Al/Ti laminated film, is formed on the transparent substrate 10 by sputtering. Then, a resist pattern is formed by a photolithography method, and dry etching is carried out by use of etching gas such as chlorine-based gas, to remove the resist pattern away. This allows the scan signal lines 201 and the auxiliary capacitance lines 202 to be formed on the transparent substrate 210 simultaneously.

Thereafter, a gate insulating film (made from, for example, silicon nitride (SiNx)), an active semiconductor layer (made from, for example, amorphous silicon), and a low resistance semiconductor layer (made from, for example, phosphor (and the like) doped amorphous silicon) are formed thereto by CVD. After that, in order to form data signal lines (source wires, source lines, source voltage lines or source bus lines) 204, drain lead-out lines 205, and auxiliary capacitance forming electrodes 206, a film made from a metal such as an Al/Ti, is formed on the transparent substrate 210 by sputtering. Then, a resist pattern is formed by the photolithography method, and dry etching is carried out by use of etching gas such as chlorine-based gas, to remove the resist pattern away. This allows the data signal lines 204, the drain lead-out lines 205, and the auxiliary capacitance forming electrodes 206 to be formed simultaneously.

An auxiliary capacitance is formed such that a gate insulating film of approximately 4000 Å is sandwiched between the auxiliary capacitance line 202 and the auxiliary capacitance forming electrode 206.

Thereafter, the low resistance semiconductor layer is dry etched by use of, for example, chloride-based gas, in order to separate the source regions from the drain regions. The TFT elements 203 are thus formed.

Next, an interlayer insulating film 207 made from acrylic photosensitive resin and the like, is coated thereto by spin coating, and contact holes (not illustrated) for electrically connecting the drain lead-out lines 205 and the pixel electrodes 208 are formed by the photolithography method. The interlayer insulating film 207 has a thickness of approximately 3 μm.

Further, the pixel electrodes 208 and a vertical alignment film (not illustrated) are formed thereto in this order.

As stated above, the present embodiment deals with an MVA liquid crystal display device, which is provided with slit patterns 211 formed to the pixel electrodes 208 which are made from, for example, ITO. Specifically, pixel electrode patterns as illustrated in FIG. 3 are obtained by: forming a film by sputtering; then, forming a resist pattern by the photolithography method; and after that, etching it by use of an etching solution such as ferric chloride.

The active matrix substrate 230 is thus obtained.

Reference Numerals 212a, 212b, 212c, 212d, 212e, and 212f in FIG. 3 are electrical connection sections of the slits formed to the pixel electrodes 8. In the electrical connection sections of the slits, alignment may be disturbed, and alignment anomaly is caused. Moreover, in addition to the alignment anomaly, a negative voltage is applied to the slits 212a through 212d most of the time. This is because the positive voltage is applied to the gate wires to turn on the TFT element 203 generally for a period on the order of microseconds, and the negative voltage is applied to the gate wires to turn off the TFT element 203 generally for a period on the order of milliseconds. For this reason, if the slits 212a through 212d are positioned on the gate wires, ionic impurities in the liquid crystal concentrate due to a gate negative DC application component. The concentrations may be viewed as display non-uniformities. The slits 212a through 212d therefore should be formed not to overlap with the gate wires planarly. It is preferable to cover the slits with the black matrix 224, as illustrated in FIG. 3.

Next, the following explains a method of manufacturing the color filter substrate 220.

The color filter substrate 220 includes: on the transparent substrate 210, a color filter layer made of the RGB (red, green, and blue) color filters 221, the black matrix (BM) 224, and the like; a counter electrode 223; the vertical alignment film 225; and the alignment controlling projections 222.

First, a negative, acrylic photosensitive resin solution in which fine carbon particles are dispersed is applied to the transparent substrate 210 by spin coating, and then dried. A black photosensitive resin layer is thus formed. After that, the black photosensitive resin layer is exposed via a photo mask, and developed to form the black matrix (BM) 224. At this time, the BM is formed so as to have openings for first (red, for example), second (green, for example), and third (blue, for example) color layers respectively in regions where the first, second, and third color layers will be formed. Each of the openings corresponds to each pixel electrode. More specifically, as illustrated in FIG. 3, the BM pattern is formed so as to have island-like shapes to shield alignment anomalous regions from light. The alignment anomalous regions are generated in electrical connection sections 212a through 212d of the slits 212a through 212f formed to the pixel electrodes 208. Further, the BM pattern is also formed to have light blocking sections on the TFT elements 203 in order to prevent an increase in leak current, which is photoexcited by external light which enters the TFT elements 203.

Next, a negative acrylic photosensitive resin solution in which a pigment is dispersed is applied thereto by spin coating, and then dried. Exposure and development are carried out with use of a photo mask to form a red layer.

After that, the second color layer (a green layer, for example) and the third color layer (a blue layer, for example) are formed in the same manner. In this way, the color filter 221 is prepared.

Further, the counter electrode 223 made from, for example, ITO is formed by sputtering. Thereafter, a positive, phenolnovolak-based photosensitive resin solution is applied thereto, and then dried. Exposure and development are carried out with use of a photo mask so as to form the vertical alignment controlling projections 222. Further, an acrylic photosensitive resin solution is applied, and then, exposed with the use of a photo mask, developed, and cured. Columnar spacers (not illustrated) for establishing a cell gap for the liquid crystal panels are thus formed.

As such, the color filter substrate 220 is formed.

In the present embodiment, the BM is made from a resin. However, the BM may be made of a metal. Further, the three primary color layers are not limited to red, green, and blue. They may be color layers of cyan, magenta, yellow, or the like, and may also include a white layer.

The following description deals with a method of manufacturing a liquid crystal panel (the first and second panels) with the color filter substrate 220 and the active matrix substrate 230 manufactured as described above.

First, the vertical alignment films are formed to surfaces of the color filter substrate 220 and the active matrix substrate 230 respectively, which surfaces will be in contact with liquid crystal. Specifically, before the alignment film is applied, the substrates are baked for degassing, and washed. After being applied, the alignment film is baked. The alignment film is washed, and then, further baked for degassing. The vertical alignment film 225 establishes an alignment direction of liquid crystal 226.

Next, the following describes a method of sealing the liquid crystal between the active matrix substrate 230 and the color filter substrate 220.

The liquid crystal sealing method may be a vacuum injection method that includes the steps of: providing a thermosetting sealing resin around the substrates in such a manner that an injection hole for injection of liquid crystal is provided in the thermosetting sealing resin; immersing the injection hole in liquid crystal while the inside the substrates is under vacuum; opening the vacuum state the atmosphere so as to inject the liquid crystal; and then, sealing the injection hole with a UV-curing resin. However, a vertical alignment liquid crystal panel needs an injection period much longer than a horizontal alignment panel when such a vacuum injection method is adopted. Therefore, the present embodiment is described by referring to one drop filling process as an example.

The UV-curing sealing resin is applied around the active matrix substrate side, and liquid crystal is dripped to the color filter substrate by a dripping method. By the one drop filling process, the liquid crystal is regularly dripped to an inner side of the sealing in an appropriate amount so as to have a desired cell gap.

Further, after the sealing resin application and the liquid crystal dripping, in order to join the color filter substrate and the active matrix substrate, an atmospheric pressure in a joining device is reduced to 1 Pa. The substrates are joined under the reduced pressure. Then, the reduced pressure is changed back to the atmospheric pressure so as to collapse the sealing section. A desired gap in the sealing section is thus obtained.

Next, the resultant structure having the desired cell gap in the sealing section is subjected to UV radiation in an UV curing device so as to preliminarily cure the sealing resin. Further, the structure is baked for a final curing of the sealing resin. At this point, the liquid crystal moves over inside the sealing resin, and fills up the cell. After being baked, the structure is separated into each liquid crystal panel. The manufacture of the liquid crystal panels is thus completed.

In the present embodiment, the first and second panels are manufactured in the same process.

Then, the following describes a method of assembling the first and second panels with each other, which are manufactured as described above.

Here, the first and second panels are washed, and then attached with the polarizers respectively. Specifically, the polarizers A and B are attached to a front surface and a back of the first panel respectively, as illustrated in FIG. 4. Further, the polarizer C is attached to a back of the second panel. The polarizers may be laminated with an optical compensation sheet, and the like, if necessary.

Then, drivers (liquid crystal driver LSIs) are connected to the panels. The description here deals with a case where the drivers are connected to the panels by a TCP (Tape Career Package) method.

For example, as illustrated in FIG. 5, an ACF (Arisotoropic Conductive Film) is preliminarily pressured and attached to terminal sections (1) of the first panel. Then, the TCPs (1) having drivers thereon are punched out from a career tape and aligned with respect to panel terminal electrodes. After that, the TCPs are heated, pressured and attached. Then, the ACF connects the circuit substrate (1) for connecting the driver TCPs (1) with each other, to input terminals (1) of the TCPs (1).

Next, the two panels are assembled with each other. The polarizer B has an adhesive layer on both surfaces thereof. The surface of the second panel is washed, and laminates of the adhesive layers of the polarizer B which is attached with the first panel are peeled off. After being accurately aligned, the first and second panels are stuck with each other. Since air bubbles exist between the panels and the adhesive layers in some cases, it is preferable to stick them under a vacuum condition.

As another sticking method, it is possible to (I) apply, to the periphery of the panels, an adhesive material which can be cured at a room temperature or at a temperature not exceeding the upper temperature limit of the panels, such as an epoxy adhesive, (II) spray plastic spacers thereto, and (III) seal the structure with, for example, fluorine oil. Preferred materials are optically isotropic liquids having a refractive index close to that of a glass substrate, and being as stable as liquid crystal.

In the present embodiment, the terminal surfaces of the first and second panels may be in the same position, as illustrated in FIGS. 4 and 5. Further, the direction of the terminals with respect to the panels, or the method of sticking the panels with each other, is not particularly limited. A mechanical sticking method using no adhesives may be adopted, for example.

Inner substrates of the two panels, which substrates face each other, are preferably as thin as possible to reduce parallax differences due to a thickness of inner glass.

With use of glass substrates, it is possible to have thin substrates from the beginning of the manufacture. A manufacture line, a size of the liquid crystal panel, and the like, determine how thin the substrates can be. The inner substrates can be a glass substrate having a thickness of 0.4 mm, for example.

There is also another method in which glass is polished or etched. An example of the method of etching glass may be a well-known art (such as Japanese Unexamined Patent Publications Nos. 3524540, and 3523239) in which a chemical treatment solution such as a 15% hydrofluoric solution is used. In this case, regions which should not be etched, such as a terminal surface, are coated with an acid resistance protection material. Then the glass is etched by being immersed in the chemical treatment solution. After that, the protection material is removed. The glass should be made thinner to around 0.1 mm to 0.4 mm by the etching. After the two panels are stuck with each other, the panels are formed integral with an illuminating device called backlight. As such, the manufacture of the liquid crystal display device 100 is completed.

Concrete examples of an illuminating device suitable to the present invention are described below. The present invention, however, is not limited to the illuminating device described below. The present invention may be modified arbitrarily if necessary.

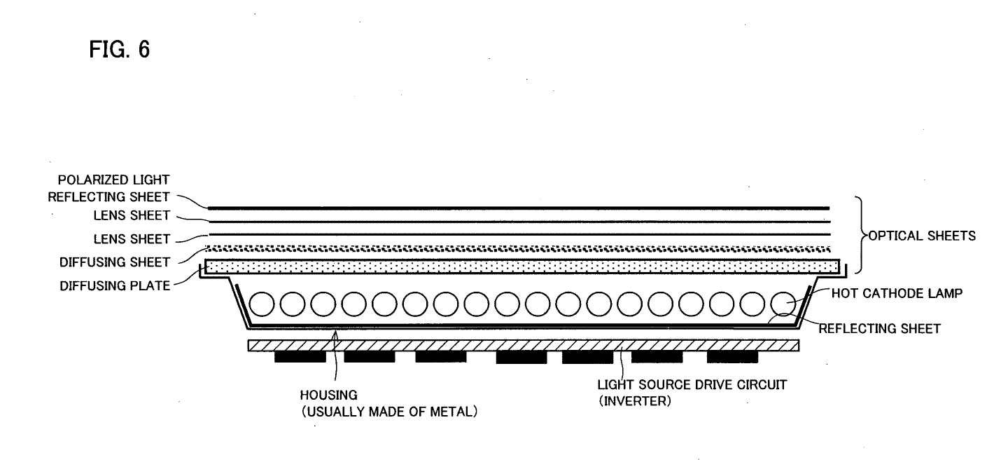

The liquid crystal display device 100 of the present invention, due to its display mechanism, requires a backlight to irradiate more light in amount than a conventional panel requires. In addition to that, it is necessary to use a blue light source with a shorter wavelength on an illuminating device side, because a short wavelength is considerably absorbed in a wavelength region in the present invention. An example of an illuminating device satisfying these conditions is illustrated in FIG. 6.

The liquid crystal display device 100 of the present invention employs a hot cathode lamp this time, in order to have luminance equal to that of the conventional liquid crystal display device. The hot cathode lamp has a feature of being able to output approximately six times more light than a cold cathode lamp, which is used for general purposes.

An example of a standard liquid crystal display may be a 37-inch WXGA-format display. In this case, 18 lamps, each of which has external diameter φ of 15 mm, are arranged on an aluminum housing. The housing includes a white light reflecting sheet made of resin foam for efficient usage of light emitted backward from the lamps. A power supply for the lamps is provided on a back of the housing, and drives the lamps on a household power supply.

A direct backlight in which a plurality of the lamps are arranged on the housing needs a translucent white resin plate to eliminate images of the lamps. Here, a 2-mm thick plate member mainly made of polycarbonate is placed on the housing above the lamps. Polycarbonate exhibits high resistance to wet warping and heat deformation. On top of the member, optical sheets (namely, in the order from the bottom, a diffusing sheet, two lens sheets, and a polarized light reflecting sheet, this time) are provided, so as to achieve predetermined optical effects. The arrangement enables the backlight to be approximately 10 times higher in luminance than a general arrangement, in which 18 cold cathode lamps, each of which has an external diameter φ of 4 mm, two diffusing sheets, and the polarized light reflecting sheet are provided. This allows the 37-inch liquid crystal display device of the present invention to have a luminance of approximately 400 cd/m².

However, the backlight of the present invention discharges 5 times more heat than a conventional backlight. Therefore, a fin and a fan are provided on a back of a back chassis of the backlight. The fin enhances the discharge of the heat to the air, and the fan forcefully ejects the heat by creating an air flow.

Mechanical members of the illuminating device also function as main mechanical members of a whole liquid crystal module. The assembled panels described above are provided to the backlight, and also a liquid crystal display controller including panel drive circuits and signal distributors, a light source power supply, and in some cases, a general household power supply are provided thereto. The manufacture of the liquid crystal module is thus completed. The assembled panels are provided to the backlight, and a framework is provided to hold the panels. This completes the manufacture of the liquid crystal display device of the present invention.

The present embodiment employs a direct backlight with hot cathode fluorescent tubes. However, depending on application, a projection type or edge light type illuminating device may be used. The light source may be cold cathode fluorescent lamps, or LEDs, OEL or electron beam fluorescent tubes. Further, optical sheets, and the like, may be selected for a suitable combination.

In the present embodiment, slits are formed to pixel electrodes of an active matrix substrate, and alignment controlling projections are formed on a color filter side, as a method of controlling an alignment direction of vertical alignment liquid crystal molecules of liquid crystal. However, as another embodiment, the slits and the projections may be transposed. Further, it is also possible to have a structure in which the electrodes on both substrate sides have slits, or use an MVA liquid crystal panel in which alignment controlling projections are formed on surfaces of the electrodes on both the substrates.

Besides the MVA type, it is also possible to use a vertical alignment film where pretilt directions (alignment processing directions) intersect with each other, which pretilt directions are determined by a pair of alignment films. Further, the VA mode, which has twist alignment of liquid crystal, may be adopted. The VA mode is called a VATN (Vertical Alignment Twisted Nematic) mode, in some cases. The VATN mode is suitable to the present invention, because it does not have a reduction in contrast due to light leakage in regions of the alignment controlling projections. The pretilt is established by light alignment, or the like.

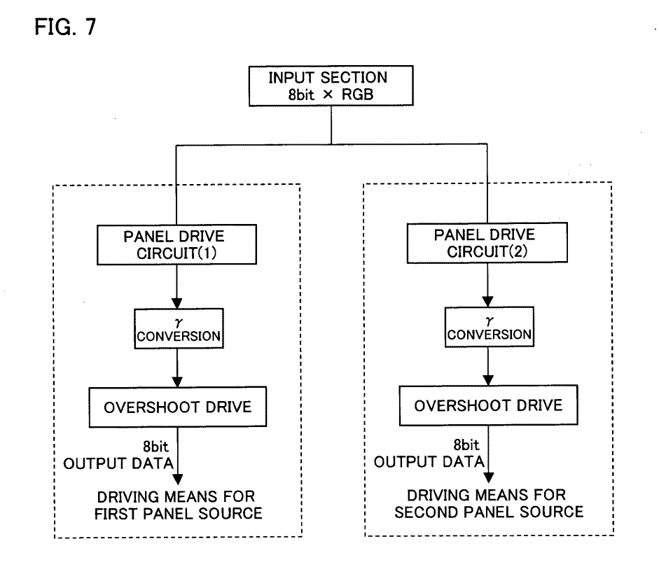

The following description explains concrete examples of a driving method implemented by the display controller of the liquid crystal display device 100 arranged described above, with reference to FIG. 7. The explanations here deal with a case of 8-bit (256 gray scales) inputs and 8-bit liquid crystal drivers.

In the panel drive circuit (1) of the display controller section, drive signal processings such as γ-correction, and overshooting, are carried out with respect to an input signal (an image source), so as to output 8-bit gray scale data to a source driver (source drive means) of the first panel.

Meanwhile, in the panel drive circuit (2), signal processing such as γ-correction, and overshooting, is carried out with respect to the input signal, so as to output 8-bit gray scale data to a source driver (source drive means) of the second panel.

The first and second panels handle 8-bit data, and the resultant output image is also 8-bit. Each output image corresponds to the input signal one to one, so that the panels produce the output image faithfully based on the input image.

In a liquid crystal display device, an afterimage would be sensed in displaying moving images due to a response period of liquid crystal. In the present embodiment, the afterimage sensed in displaying moving images is reduced with the use of two liquid crystal panels. Specifically, luminance ratios of the signals which will be inputted to each of the panels are appropriately adjusted. Thereby, the signals are distributed so that each of the panels has the luminance ratio for a short response period. The afterimage is thus hardly sensed. A driving method and a drive device for attaining the object are described below.

In the present embodiment, the liquid crystal display device 100 includes the display controller 400 for driving two liquid crystal panels (the first and second panels) independently, as illustrated in FIG. 4.

The display controller 400 includes: the panel drive sections (1) and (2) for generating drive signals for each of the panels; and also, the signal distributing section 401 for distributing, to each of the panels, image source signals as input signals; and the luminance ratio adjusting section (gray scale adjusting means) 402 for adjusting the luminance ratios of the signals distributed by the signal distributing section 401.

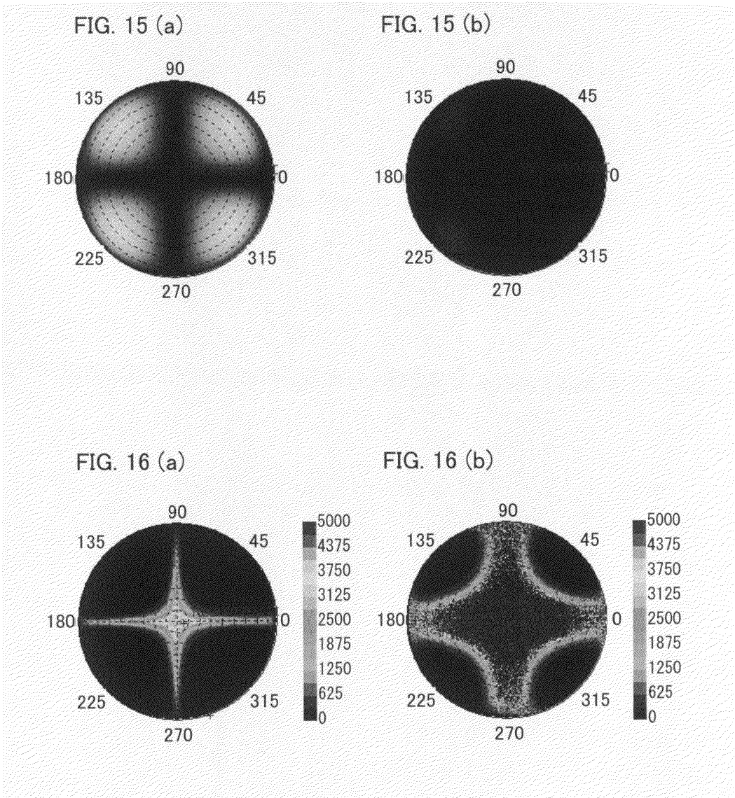

The luminance ratio adjusting section 402 includes: a gray scale-luminance ratio converting block 1 (which is gray scale-luminance ratio converting means); a combination selecting circuit 2 (which is selecting means); a frame memory 3 (which is combination storing means, means for storing gray scale-luminance ratio conversion results, and means for storing luminance ratio-gray scale conversion results); and luminance ratio-gray scale converting blocks 4a and 4b (which are luminance ratio-gray scale converting means), as illustrated in FIG. 17.

The gray scale-luminance ratio converting block 1 converts, into luminance ratios, gray scale data of the input signals which have been distributed for the first and second panels in the signal distributing section 401.

Generally, under the ITU standard, a luminance ratio Ynorm with respect to a gray scale n is represented by the following formula. In the formula, N is a maximum gray scale. That is, a luminance ratio is a ratio found from a relationship between an arbitrary gray scale n, and a maximum gray scale N in a liquid crystal panel.

Ynorm=(n/N)^{2.2} (1)

In the present embodiment, for additions of luminance, it is necessary to convert the input data of the gray scales into the luminance ratios by use of the formula above. The gray scale-luminance ratio converting block 1 performs calculations for the conversion.

In the same manner, the luminance ratio-gray scale converting blocks 4a and 4b convert the luminance ratio data of each panel back into the gray scale data in accordance with gray scale/luminance ratio properties of the first and second panels for displaying images. This function depends on the properties of each panel. In a case where each panel is the liquid crystal panel of the ITU standard, the function will be an inverse function of the calculations performed by the gray scale-luminance ratio converting block 1.

Meanwhile, the combination selecting circuit 2, which is provided between the gray scale-luminance ratio converting block 1 and the luminance ratio-gray scale converting block 4, selects the luminance ratio for each of the two panels by carrying out calculations with the luminance ratio data.

Here, the description deals with a method of selecting luminance ratios of each panel in the combination selecting circuit 2.

First, a luminance ratio of one picture element inputted at a time point t is referred to as “Ynorm, t”. The luminance ratios of the first and second panels referred to as “Ynorm, t, A” and “Ynorm, t, B” respectively. These luminance ratios Ynorm, t, Ynorm, t, A, and Ynorm, t, B are discrete values corresponding to gray scales in a one-to-one relationship.

Further, the combination selecting circuit 2 includes the frame memory 3, and stores information of the luminance ratio information of each panel on last frame (one frame prior to the current frame). The luminance ratio information of each panel on last frame is referred to as luminance ratios “Ynorm, t−1, A”, and “Ynorm, t−1, B”.

First, a method of finding the luminance ratios Ynorm, t, A and Ynorm t, B from the luminance ratio Ynorm, t. is described below.

The luminance ratio Ynorm, t, A is changed from 0 to 1 by, for example, 0.005. Each resultant value is calculated for the best value. That is, the calculations are carried out to find a combination between the luminance ratios Ynorm, t, A and Ynorm, t, B for the shortest response period.

A luminance ratio of one combined panel will be an average luminance ratio of the two panels with weight. Therefore, a relationship between the luminance ratio Ynorm, t, and the luminance ratios Ynorm, t, A and Ynorm, t, B is represented by the following formula.

Ynorm,t=(Ynorm,t,A+Ynorm,t,B)×0.5 (2)

By use of this formula, the luminance ratio Ynorm t, B can be found with the findings of the luminance ratios Ynorm, t and Ynorm, t, A. These values, however, are discrete values, so that the closest values will be selected.

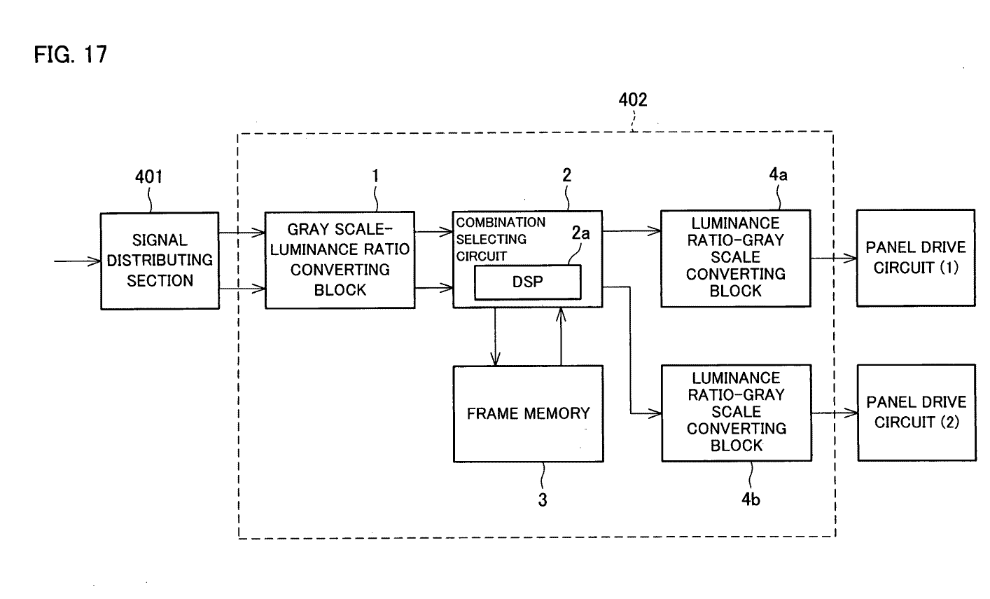

Next, a digitalized display response period of liquid crystal is represented by a function f(x, y). With the function, if an initial luminance is x, and an end luminance is y, the resulting value, i.e. f(x, y) will be, for example, values shown in FIG. 18.

The following explains FIG. 18 in detail. In FIG. 18, initial luminance ratios (a white luminance is normalized to 1.00, and a black luminance is normalized to 0.00) are shown in a longitudinal direction, and end luminance ratios are shown in a horizontal direction. Necessary response periods for luminance to change from 0% to 90% are shown. The shown luminance ratios are changed by 0.05, for example. It is better in consideration of accuracy to carry out an actual experiment with luminance ratios changed by 0.005. In FIG. 18, the values of the response periods are not the periods needed for luminance to change from 0% to 100%. This is merely because the values of the response periods of the liquid crystal are generally provided as the periods needed for luminance to change from 10% to 90%. Under the VESA standard, the response period is provided as a period needed for luminance to change from a point a signal is inputted to a point the luminance changes to 90%.

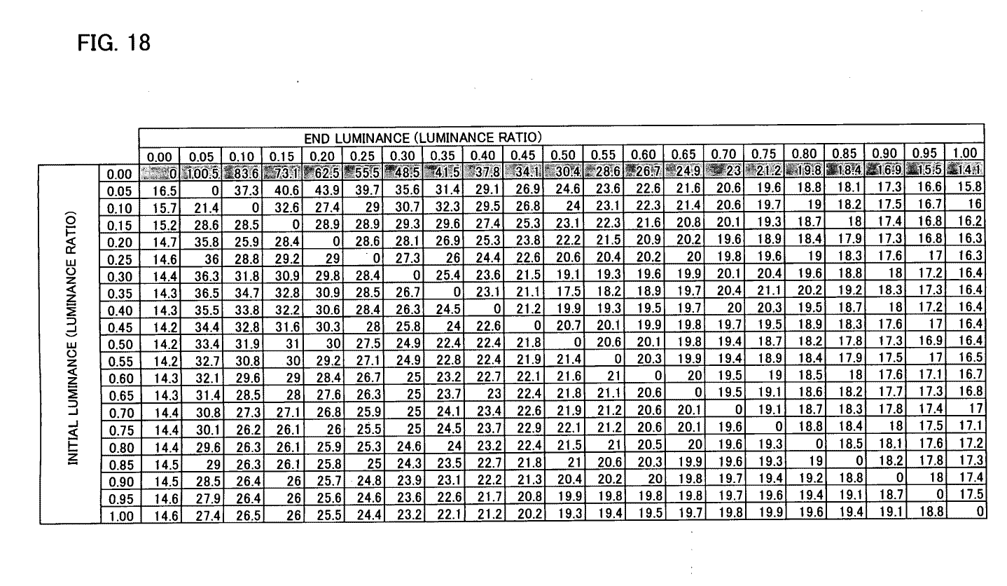

FIG. 19 is a graph of FIG. 18, showing a relationship between an initial luminance ratio of 0.00 and end luminance ratios of 0.00 to 1.00. FIG. 19 demonstrates that when the initial luminance ratio is 0.00, a smaller difference between the initial luminance ratio and the end luminance ratio results in a longer response period RT. That is, there is a range where the response period is considerably slow, and exceeds 100 ms. This is a property of the liquid crystal in the MVA mode and an ASV mode. In these modes, when an applied voltage changes from 1V to 2V or 3V in the black display, the response period becomes considerably slow. This property cannot be eliminated even if the liquid crystal is driven by overshoot drive The driving method of the present embodiment efficiently avoids this problem. In other words, avoiding a combination for a slow response period makes it possible to reduce a phenomenon in which a response is quite slow in a specific halftone.

As described above, the luminance ratio data of last frame is stored based on, for example, the response periods RT shown in FIG. 18. Thus, a response period RTA of the first panel is represented by the following formula.

RTA=f(Ynorm,t−1,A,Ynorm,t,A) (3)

In the same manner, since the luminance ratio Ynorm, t, B can be found by use of the formula (2), the response period RTB of the second panel can be found by use of the following formula (4).

RTB=f(Ynorm,t−1,B,Ynorm,t,B) (4)

When the first and second panels are assembled with each other, the response period of the combined panel will be the longer one selected from the results from the formulas (3) and (4).

As such, the response period RT is found by calculations with use of all the luminance ratios Ynorm, t, A, so that the luminance ratio Ynorm, t, A for the shortest response period is selected.

The selection of the luminance ratio Ynorm, t, A results in a selection of the luminance ratio Ynorm, t, B, with use of the formula (2).

The results are sent to the luminance ratio-gray scale converting blocks 4a and 4b respectively.

In this way, the response period can be reduced.

Further, it is possible to have overshoot drive effects simultaneously. This is achieved in such a manner that, in place of using constant values, the luminance ratios Ynorm, t, A and Ynorm, t, B are found from luminance ratio values that the luminance ratios of last frame (Ynorm, t, A and Ynorm, t, B) reach in a period of one frame.

This is explained below with concrete examples.

Here, as shown in FIG. 18, a response period RT of 100.5 ms is necessary in order to change the luminance ratio from an initial luminance ratio of 0.00 (in the black display) to an end luminance ratio of 0.05. Accordingly, a liquid crystal display device with a single panel needs the response period of 100.5 ms in order to change the luminance ratio from 0.00 to 0.05. With the structure in which two panels are assembled with each other, for example, the luminance ratio of one of the panels is set to be 0.00, and the luminance ratio of the other panel is changed from 0.00 to 0.10. It takes 83.6 ms to change the luminance ratio from 0.00 to 0.10, as shown in FIG. 18, so that the response period can be improved by approximately 17%.

In the same manner, with more panels for constituting the liquid crystal display device, a shorter response period can be achieved.

The following is a formula of the explanation above in a form of the formulas (3) and (4).

RT=f(Ynorm,0.00,Ynorm,0.05)=100.5 ms.

That is, under the same condition, the response period of 100.5 ms has been conventionally necessary for a single panel to display images. On the other hand, in the present embodiment, two panels are assembled with each other, and driven and displayed independently.

As described above, the first panel is driven such that the initial luminance ratio is set to be 0.00 (in the black display), and the end luminance ratio is set to be 0.00. Here, the following formula is found with reference to the formula (3) and FIG. 18.

RTA=f(Ynorm,0.00,A,Ynorm,0.00,A)=0 ms.

Meanwhile, the second panel is driven such that the initial luminance ratio is set to be 0.00 (in the black display), and the end luminance ratio is set to be 0.10. In this case, the following formula is found with reference to the formula (4) and FIG. 18.

RTB=f(Ynorm,0.00,B,Ynorm,0.10,B)=83.6 ms

An average luminance ratio of the first and second panels with weight is represented by the following formula with reference to the formula (2).

Ynorm,t=(Ynorm,0.00,A+Ynorm,0.10,B)×0.5=0.05

This value of 0.05 is the same as the end luminance ratio of the single panel structure. Accordingly, when the first and second panels are driven and displayed as described above, a display drive period is 83.6 ms. This is shorter than 100.5 ms, which is the display drive period of the single panel structure.

The examples above merely show a combination of the first and second panels. Therefore, it is possible to realize a much shorter response period RT by selecting another combination.

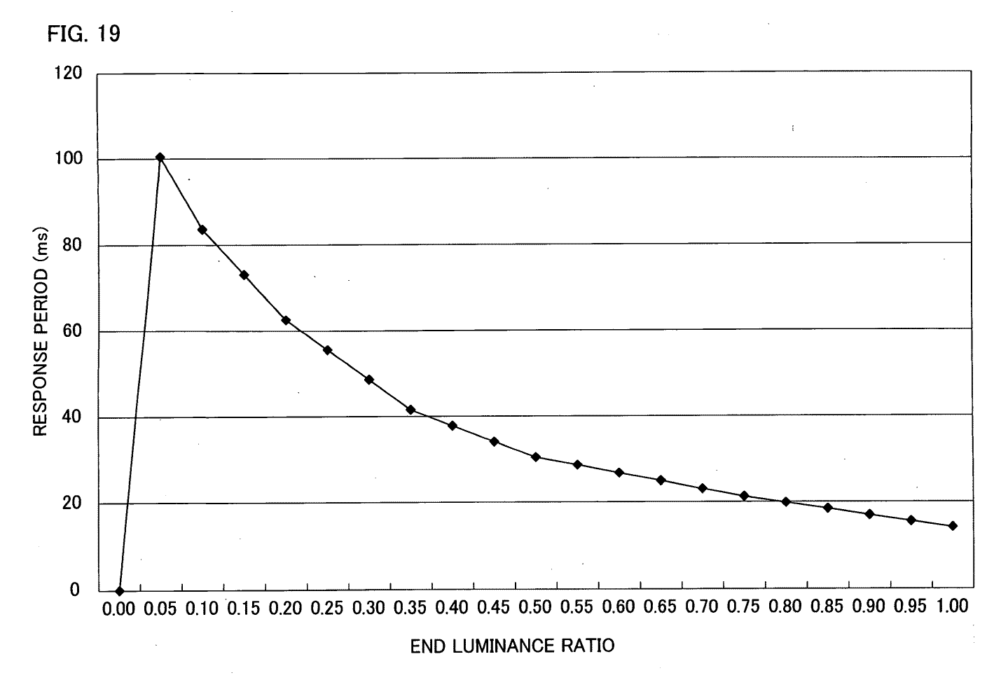

Now, FIG. 20 shows data of a single panel, which data shows the response periods at each gray scale on last frame and the current frame. In the table of FIG. 20, a gray scale luminance (transmittance) ratio of two panels is set to “γ=1.11”. With this, the response period of each of the two panels is represented by the following formulas.

An upper panel: V(n)=(n/255)^{1.1}

A lower panel: V(n)=(n/255)^{1.1}

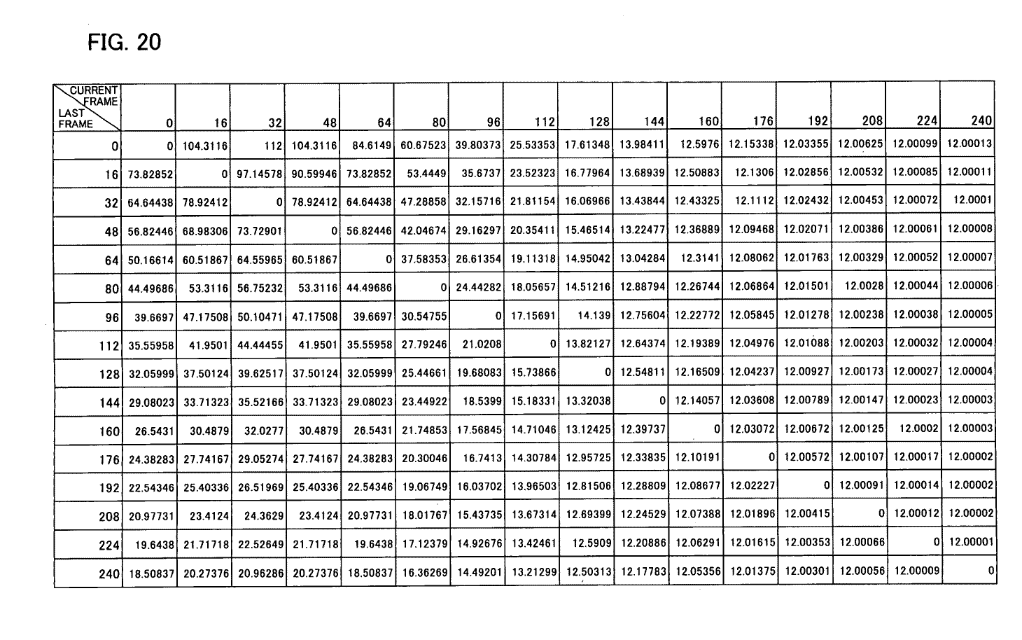

FIG. 21 is a graph based on the table of FIG. 20. The graph shows a relationship between a response period (data of a single panel) and a gray scale in a case where the gray scale on last frame is 0.

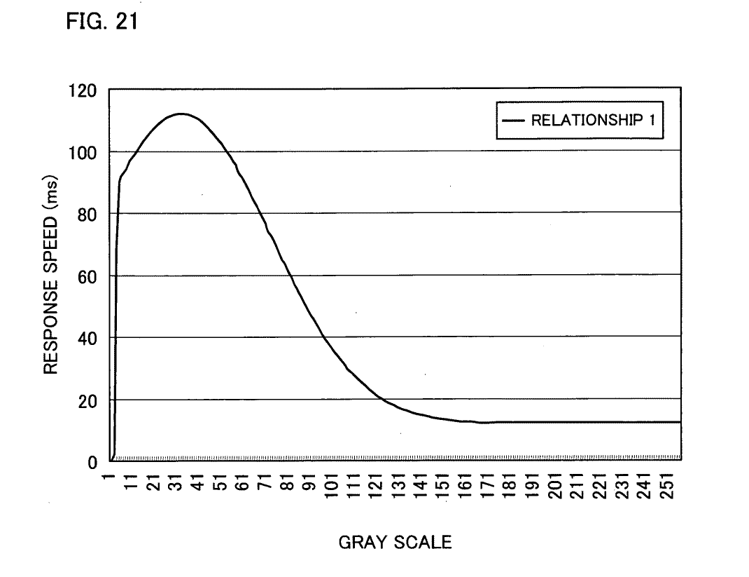

In a case of two panels stuck with each other, in order to reduce the response period RT according to the relationship between the response period and the gray scale of the panels, as showed in FIG. 21, the combination for the shortest response period RTA is selected by use of a look-up table T1 showed in FIG. 22, for example.

The look-up table T1 shows gray scales of the first (upper) and second (lower) panels, which gray scales should be set on the current frame with respect to those on last frame.

In the look-up table T1, for example, where the gray scales of the first and second panels are 0 on last frame, values show how to relate the gray scales of the first and second panels on the current frame in order to reduce the response period.

As such, in the liquid crystal display device of the present embodiment, two panels are stuck with each other, and the panels display images based on gray scales respectively and independently.

In this case, the response period of the liquid crystal display device is an average response period of the two panels with weight. Thus, it is possible to reduce the phenomenon where the response period is slow in a specific halftone, because the combination of the gray scales for a long response period is avoided when the first and second panels display images.

As described above, in the present embodiment, examples are made under a condition where both of two panels are set to “γ=1.1” independently. The present invention, however, is not limited to this. Two panels may differ in γ value in such a manner that the γ value becomes “γ=2.2” as a whole.

For this reason, the present invention can provide a liquid crystal display device and a driving method thereof, both of which can reduce a response period.

Further, in the liquid crystal display device of the present embodiment, the combination selecting circuit 2 of the display controller 400 selects a combination for the shortest response period from among the gray scale combinations of each panel, with which gray scale combinations, for example, a response period of a gray scale (an average response period of each panel with weight) in displaying images becomes shorter than a response period of, for example, the single panel structure.

Therefore, it becomes possible to display images in the shortest display response period.

Furthermore, in the liquid crystal display device of the present embodiment, the frame memory 3 of the display controller 400 memorizes, in a table form, the gray scale combinations of each panel, with which gray scale combinations a response period of a gray scale (an average response period of each panel with weight) in displaying images becomes shorter than a response period of, for example, the single panel structure.

Thereby, it becomes possible to select various combinations from the table to display images easily and promptly.

Moreover, in the liquid crystal display device of the present embodiment, the display controller 400 includes the gray scale-luminance ratio converting block 1 for converting the gray scales into the luminance ratios, so that it becomes possible to display gray scale data at a high speed.

Further, in the liquid crystal display device of the present embodiment, the display controller 400 includes the gray scale-luminance ratio converting block 1 for converting the gray scales into the luminance ratios, and the luminance ratio-gray scale converting blocks 4a and 4b for converting, into the gray scales, the luminance ratios of each panel for the shortest response period in displaying images, which shortest luminance ratio is selected by the combination selecting circuit 2.

Thereby, it becomes possible to display the gray scale data at a highest speed.

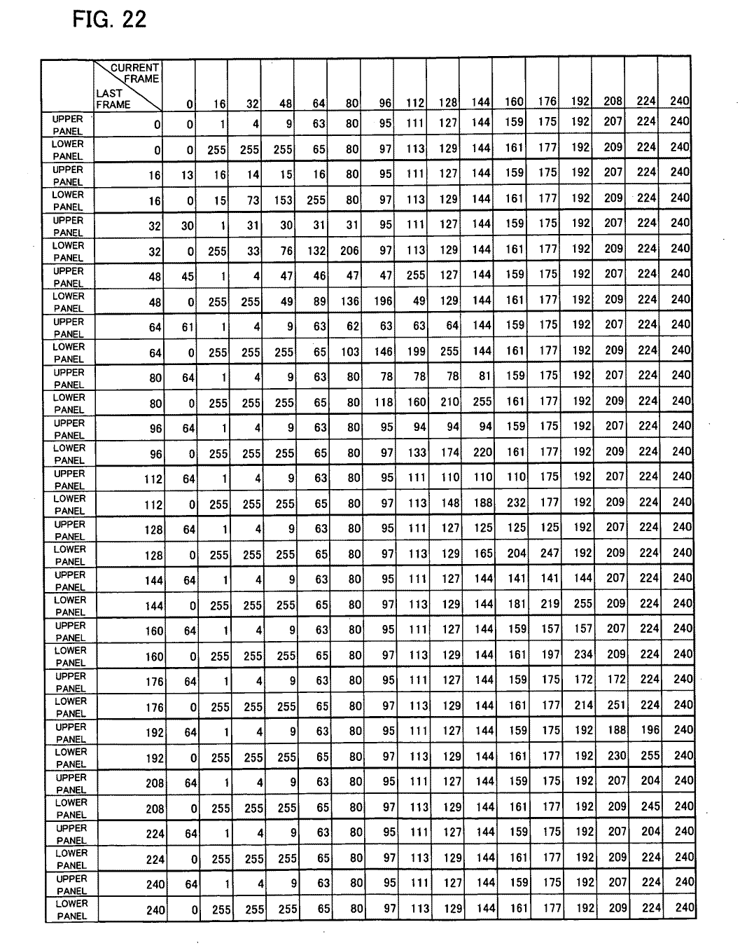

Furthermore, in order to realize it more conveniently, the present embodiment may be arranged such that an end luminance that includes regions over 50 ms in FIG. 18 is prohibited, as shown in FIG. 23, for example.

With the arrangement, the slow response periods are avoided while it becomes unnecessary to refer to last frame data. Thereby, it is possible to cut costs by omitting the frame memory.

Especially, a decrease in thickness of a cell layer results in a significant decrease in yield rate, but the response period becomes shorter, as shown in FIG. 23. In such a case, this method is quite efficient.

In the present embodiment, a DSP (Digital Signal Processor) 2a is used as the combination selecting circuit 2, but the present invention is not particularly limited to this. For example, the combination selecting circuit 2 may be another circuit, such as an analogue circuit. Further, the system is positioned outside the liquid crystal module in the present embodiment, but it is possible to arrange the system in the liquid crystal module or the liquid crystal panel.

### Second Embodiment

The following description deals with another embodiment of the present invention. Arrangements that are not described here are the same as in the first embodiment. Accordingly, members having the same functions as the members illustrated in figures of the first embodiment have the same reference numerals as in the first embodiment, and the explanations thereof are omitted, for convenience.

In addition to the structures of the liquid crystal display device of the first embodiment, a liquid crystal display device of the present embodiment includes the following algorithms in selecting the luminance ratios Ynorm, t, A and Ynorm, t, B:

(i) In calculations for the response period RT, the present embodiment checks whether the resulting values are shorter than a period of one frame or not.

(ii) The present embodiment selects one that has the smallest difference between the luminance ratios Ynorm, t, A and Ynorm, t, B, when a plurality of the values for the shorter response period than the period of one frame are found.

Now, in a case of NTSC, one frame has a frequency of 60 Hz and a period of 16.7 ms. In a case of PAL, or SECAM, one frame has a frequency of 50 Hz and a period of 20 ms.

A reason to have such an arrangement is that a reduction in difference between the luminance ratios Ynorm, t, A and Ynorm, t, B allows a reduction in a surface roughness feeling in still images.

Thus, in the liquid crystal display device of the present embodiment, the DSP2a, which is judging means of the combination selecting circuit 2, judges whether a response period of the combination is shorter than the display period of one frame or not, when selecting the combination of the luminance ratios of each panel for the shortest response period.

Therefore, when the response period is longer than the display period of one frame, it is necessary to select the combination so that the response period becomes as short as possible. This is regarded as a result that the response period is reduced.

Meanwhile, when the response period is shorter than the display period of one frame, it is unnecessary to have a further shorter response period. Therefore, it is possible to select a combination for high display quality from among combinations that can achieve a shorter response period than the display period of one frame.

This selection of the combination in connection with the display quality becomes more important with the liquid crystal panels themselves improved in response period. For example, a reduction in thickness of an existing liquid crystal display device, as shown in FIG. 18, results in a reduction in response period, as shown in FIG. 23. Under this situation, combination options increase. By selecting the best combination from among the increased options, it becomes possible to realize a liquid crystal display device having high display quality and a short response period.

Further, in the liquid crystal display device of the present embodiment, by the calculations performed by the DSP2a, the combination selecting circuit 2 selects one having the smallest difference between the response periods of each panel, when a plurality of combinations of the luminance ratios of each panel are found for the shorter response period than the period of one frame.

Thereby, the difference between the luminance ratios of each panel is reduced so as to be hardly recognized with visual characteristics of human. The liquid crystal display device thus also has an effect to prevent degradation in display quality.

### Third Embodiment

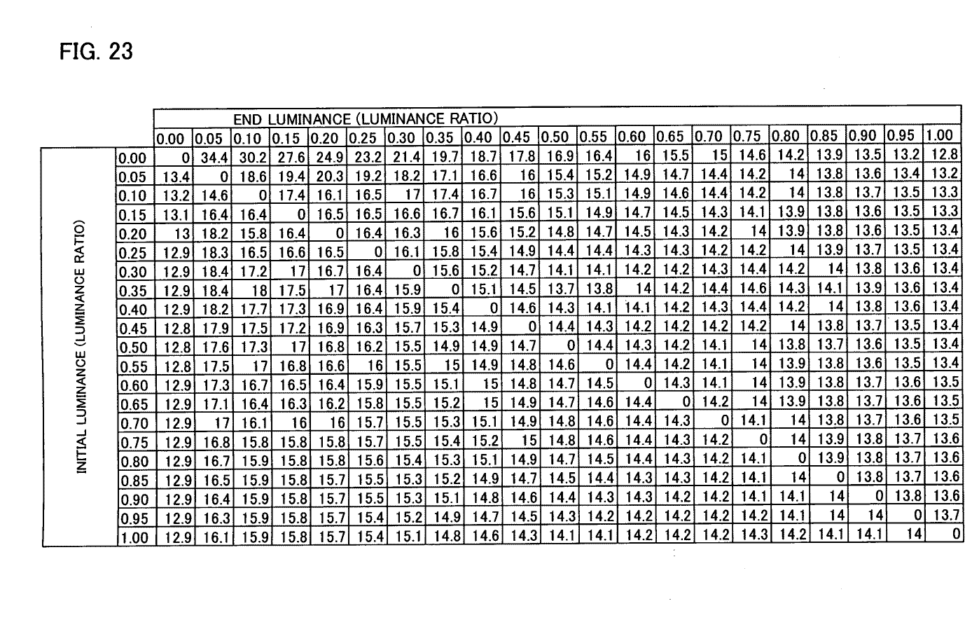

The following describes a television receiver adopting the liquid crystal display device of the present invention with reference to FIGS. 24 through 26.

FIG. 24 illustrates a circuit block of a liquid crystal display device 601 for the television receiver.

The liquid crystal display device 601, as illustrated in FIG. 55, includes a Y/C separation circuit 500, a video chroma circuit 501, an A/D converter 502, a liquid crystal controller 503, a liquid crystal display panel 504, a backlight drive circuit 505, a backlight 506, a microcomputer 507, and a gradation circuit 508.

The liquid crystal panel 504 includes a first liquid crystal panel and a second liquid crystal panel, but any arrangement described in the aforementioned embodiments can be applied.

With the liquid crystal display device 601 adopting the arrangement described above, first of all, an input picture signal of a television signal is inputted into the Y/C separation circuit 500, and then separated into a luminance signal and a color signal. In the video chroma circuit 501, the luminance signal and color signal are converted into R, G and B, which are three primary colors, and after that, the analogue RGB signals are converted into digital RGB signals by the A/D converter 502, and thereafter, inputted into the liquid crystal controller 503.

To the liquid crystal panel 504, the RGB signals from the liquid crystal controller 503 are inputted at a prescribed timing, at the same time, gradation voltages of R, G and B are provided from the gradation circuit 508, thereby displaying images. The microcomputer 507 controls a whole system, including these processings.

Examples of the picture signal described above encompass a picture signal based on a television broadcast, a picture signal taken with a video camera, a picture signal provided via the Internet, and other various picture signals.

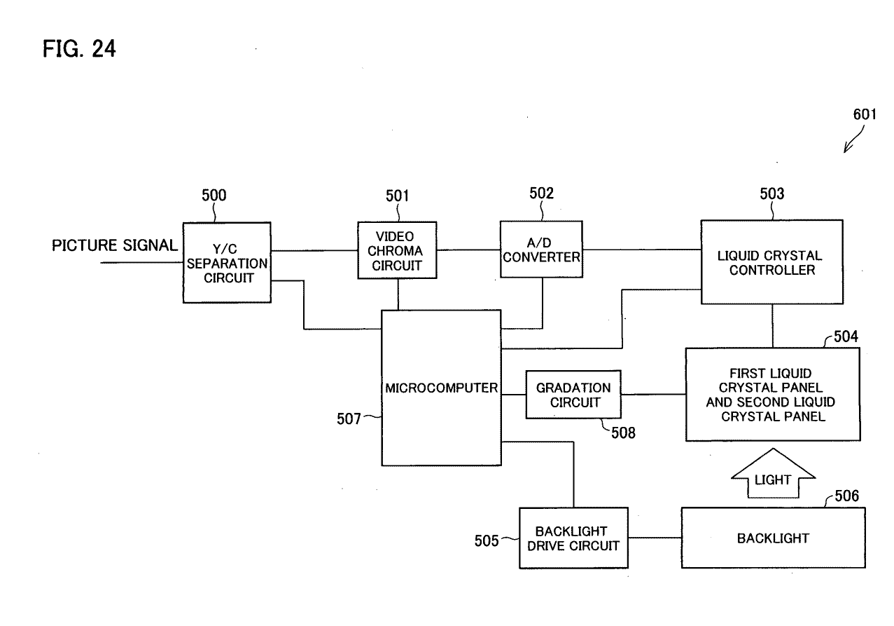

Further, a tuner section 600 illustrated in FIG. 25 receives a television broadcast and outputs the picture signal thereof, and the liquid crystal display device 601 displays images (pictures) according to the picture signal outputted from the tuner section 600.

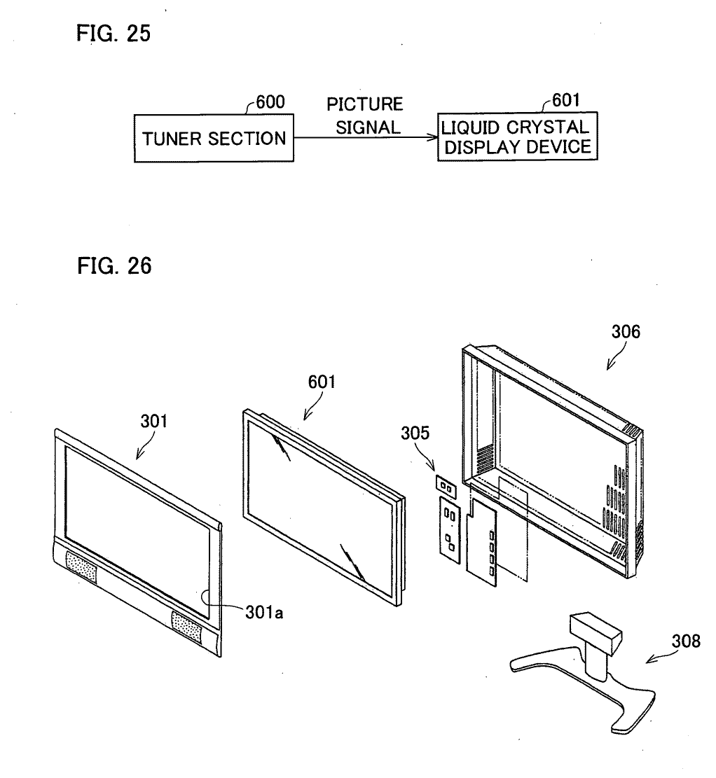

In a case where the liquid crystal display device is used in a television receiver, for example, as illustrated in FIG. 26, a first housing 301 and a second housing 306 covers the liquid crystal display device 601 therebetween, and hold it.

The first housing 301 includes an opening portion 301a for transmitting the images displayed at the liquid crystal display device 601.

Further, the second housing 306 covers a backside of the liquid crystal display device 601, and includes a control circuit 305 for controlling the liquid crystal display device 601, and a supporting member 308 attached thereunder.

As described above, with the television receiver or a picture monitor, which adopts the aforementioned arrangement, it is possible to display images having high contrast, and high display quality with excellent moving image properties.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A liquid crystal display device of the present invention is excellent in moving image properties, and can enhance contrast considerably. The present invention is thus applicable to a television receiver, a monitor for movies, a monitor for a TV broadcast, and the like.

1. A liquid crystal display device in which a plurality of liquid crystal panels is optically stacked with each other, and each of the liquid crystal panels outputs an image based on an image source, comprising:
display control means for outputting images to each of the liquid crystal panels respectively and independently so that the images displayed on the liquid crystal panels are stacked with each other to form one image corresponding to the image source,
the display control means comprising:
gray scale adjusting means for adjusting gray scales of the image outputted to each of the liquid crystal panels so that a display response period in combining the gray scales becomes shorter than a standard predetermined display response period, when one combined gray scale is obtained by combining the gray scales of the image outputted to each of the liquid crystal panels.

2. The liquid crystal display device according to claim 1, wherein the gray scale adjusting means comprising:
gray scale-luminance ratio converting means for converting gray scales of the inputted image source into luminance ratios found from relationships between the gray scales and a maximum gray scale;
selecting means for selecting a combination of the luminance ratios for a shortest display response period from among combinations of the luminance ratios with which the display response period in combining the gray scales becomes shorter than the standard predetermined display response period, when one combined gray scale is obtained by combining the gray scales of the image outputted to each of the liquid crystal panels in accordance with the luminance ratios converted by the gray scale-luminance ratio converting means; and
luminance ratio-gray scale converting means for converting, into gray scales, each of the luminance ratios in the combination selected by the selecting means for the shortest display response period.

3. The liquid crystal display device according to claim 2, further comprising:
luminance ratio combination storing means for storing the combinations of the luminance ratios with which the display response period in combining the gray scales becomes shorter than the standard predetermined display response period, wherein:
according to the luminance ratios converted by the gray scale-luminance ratio converting means, the selecting means selects the combination of the luminance ratios for the shortest display response period from the combinations of the luminance ratios stored in the luminance ratio combination storing means.

4. The liquid crystal display device according to claim 2, wherein the selecting means comprises:
judging means which provides the standard predetermined display response period as a display period of one frame, and judges the combination of the luminance ratios shorter than the display period of one frame, as the combination of the luminance ratios for the shortest display response period.

5. The liquid crystal display device according to claim 4, wherein:
when the judging means judges that there is a plurality of combinations of the luminance ratios for the shorter display response period than the display period of one frame, the selecting means selects one having a smallest difference in display response period between the liquid crystal panels, as the combination of the luminance ratios for the shortest display response period.

6. The liquid crystal display device according to claim 1, wherein:
when according to gray scales of a prior frame on each of the liquid crystal panels, one combined gray scale is obtained by combining the gray scales of the image outputted to each of the liquid crystal panels, the gray scale adjusting means adjusts the gray scales of the image respectively outputted to each of the liquid crystal panels so that the display response period in combining the gray scales becomes shorter than the standard predetermined display response period.

7. The liquid crystal display device according to claim 1, comprising:
polarized light absorption layers, which form crossed Nicols and sandwich the liquid crystal panels therebetween.

8. A liquid crystal display method in which a plurality of liquid crystal panels is optically stacked with each other, and each of the liquid crystal panels outputs an image based on an image source in order to display the image, comprising the steps of:
outputting images to each of the liquid crystal panels respectively and independently so that the images displayed on the liquid crystal panels are stacked with each other to form one image corresponding to the image source; and
adjusting the gray scales of the image outputted to each of the liquid crystal panels so that the display response period in combining the gray scales becomes shorter than the standard predetermined display response period, when one combined gray scale is obtained by combining the gray scales of the image outputted to each of the liquid crystal panels.

9. A television receiver including a tuner section for receiving a television broadcast, and a display device for displaying the television broadcast received at the tuner section, wherein:
the display device is a liquid crystal display device in which a plurality of liquid crystal panels is optically stacked with each other, and each of the liquid crystal panels outputs an image based on an image source, the liquid crystal display device comprising:
display control means for outputting images to each of the liquid crystal panels respectively and independently so that images displayed on the liquid crystal panels are stacked with each other to form one image corresponding to the image source, the display control means comprising:
gray scale adjusting means which adjusts gray scales of the image outputted to each of the liquid crystal panels so that a display response period in combining the gray scales becomes shorter than a standard predetermined display response period, when one combined gray scale is obtained by combining the gray scales of the image outputted to each of the liquid crystal panel.

10. The liquid crystal display device according to claim 1, further comprising:
luminance ratio combination storing means for storing the combinations of the luminance ratios with which the display response period in combining the gray scales becomes shorter than the standard predetermined display response period, wherein:
according to the luminance ratios converted by the gray scale-luminance ratio converting means, the selecting means selects the combination of the luminance ratios for the shortest display response period from the combinations of the luminance ratios stored in the luminance ratio combination storing means.

11. The liquid crystal display device according to claim 1, wherein the selecting means comprises:
judging means which provides the standard predetermined display response period as a display period of one frame, and judges the combination of the luminance ratios shorter than the display period of one frame, as the combination of the luminance ratios for the shortest display response period.

12. The liquid crystal display device according to claim 1, wherein:
when the judging means judges that there is a plurality of combinations of the luminance ratios for the shorter display response period than the display period of one frame, the selecting means selects one having a smallest difference in display response period between the liquid crystal panels, as the combination of the luminance ratios for the shortest display response period.

13. The liquid crystal display device according to claim 2, wherein:
when the judging means judges that there is a plurality of combinations of the luminance ratios for the shorter display response period than the display period of one frame, the selecting means selects one having a smallest difference in display response period between the liquid crystal panels, as the combination of the luminance ratios for the shortest display response period.

14. The liquid crystal display device according to claim 11, wherein:
when the judging means judges that there is a plurality of combinations of the luminance ratios for the shorter display response period than the display period of one frame, the selecting means selects one having a smallest difference in display response period between the liquid crystal panels, as the combination of the luminance ratios for the shortest display response period.
